(19) United States
(12) Patent Application Publication
(10) Pub. No.: US 2018/0271016 A1
(43) Pub. Date: Sep. 27, 2018

(54) HARVESTER HEADER CONTROL SYSTEM, METHOD AND APPARATUS

(71) Applicant: Milano Technical Group Inc., Merced, CA (US)

(72) Inventors: Dominic Milano, MERCED, CA (US); Max M. Shui, Merced, CA (US); Steven James Fleming, Merced, CA (US)

(21) Appl. No.: 15/933,234

(22) Filed: Mar. 22, 2018

Related U.S. Application Data
(60) Provisional application No. 62/475,093, filed on Mar. 22, 2017.

(51) Int. Cl. A01D 41/14; A01D 75/00; A01D 33/00; A01D 91/04; G01S 17/08; G01S 17/88

(52) U.S. Cl. CPC A01D 41/141; A01D 75/00; A01D 33/00; A01D 45/006; G01S 17/08; G01S 17/88; A01D 91/04

(57) ABSTRACT

The harvester header height control system allows automatic adjustment of the header height as the harvester moves across a field to optimize the harvest of the produce in the field. The header height control system adjusts for the topography of the field, the density and health of the plants in the field and the speed of the harvester.

### CROSS REFERENCE TO RELATED APPLICATIONS

This application claims priority from U.S. Provisional Patent Application No. 62/475,093 filed on Mar. 22, 2017 and entitled “Harvester Header Control System, Method and Apparatus,” which is incorporated herein by reference in its entirety for all purposes.

### FIELD OF THE DISCLOSURE

The present disclosure relates generally to crop harvesting equipment, and more particularly, to methods and systems for controlling the header of a harvester.

### BACKGROUND

Harvesting equipment is often specialized for specific crops. For example, a corn harvester is optimized for harvesting corn and would not perform well attempting to harvest tomatoes or potatoes. Each type of harvester has a type of header that corresponds to the intended crop (e.g., corn, wheat, rice, bell peppers, tomatoes, onions, garlic, carrots, potatoes, etc.).

FIGS. 1A and 1B include overhead views 120A-G and corresponding side views 122A-G of multiple row crops. By way of example, 120A is an overhead view of tomato plants 124A and tomato produce 126A. Note how the tomato plants 124A and produce 126A cover most of the area of the surface 104 of the field 102 making it difficult to see the surface of the field. In the corresponding side view 122A, note how the tomato produce 126A has varying height relative to the surface 104 of the field 102 and that some of the produce is resting on or very near the surface and some of the produce is substantially above the surface.

The row crop tomato plants 124A and produce 126A often substantially covers the surface 102 of the field 104, thus adding further difficulty to accurately differentiate the surface of the field from the crop. As shown in FIG. 1A, in portions of the field 104 the tomato plants 124A and tomatoes 126A cover as much as 97 percent or more of the surface 102 of the field. This dense coverage of the surface 102 of the field 104 further adds difficulty to accurately ascertain, maintain and control a harvester header at an ideal harvesting height relative to the surface of the field, for the specific type row crop.

In another example, 120B is an overhead view of carrots in a field 102 and a corresponding cutaway side view 122B of the carrots 126B in the field. The depth of the carrots 126B vary with respect to the surface 104 of the field 102. In the remaining views 120C-H and 122C-H also show similar variations in locations of the row crop plants 124C-H and respective produce 126C-H relative to the surface 104 of the field 102 and how the surface of the field is obscured from view by the respective row crop plants.

One of the problems with controlling harvesters is accurate and timely control the height of the header relative to an uneven surface 102 of the field 104 containing the row crop. FIG. 1C illustrates a typical row crop field 104. The field 104 includes furrows 130 separating each of the rows of tomato plants 124A (or other row crop plants 124A-H). A first portion 104A, of the field 104, is substantially consistent contour, e.g., flat or constant grade, with substantially straight rows of plants 124A and furrows 130.

A second portion 104B, of the field 104, includes multiple surface variations including an uneven contour of the surface 102 with irregular dips 102A-D, rises 102E-G, cracks 102H-J, ruts 102K-M and irregular furrows 130A. The irregular furrows can be non-straight and the dips 102A-D, rises 102E-G, cracks 102H-J and ruts 102K-M can result in inconsistent relative distances between the furrows and the surface 102 of the field in the rows of plants 120A. As a result of the multiple variations 102A-M, 106 and 108, the furrows 130A cannot reliably be used as a reference for the level of the surface 102 for harvesting the plants 124A and produce 126A.

FIG. 1D is a profile view of the second portion 104B of the field 104. The second portion 104B includes rising areas 106 and falling areas 108 of varying grades upward 152A or downward 152B from an approximate baseline grade 110. All of these surface variations 102A-M, 106, 108, 152A and 152B add difficulty to accurately ascertain, maintain and control the header 150 of the harvester 140 at a desired harvesting height 155 relative to the surface 102 of the field 104. The desired harvesting height 155 allows the header 150 to efficiently harvest a maximum amount of the produce 126A and a minimum amount of dirt from the surface 102 of the field 104.

If the header harvesting height 155 is too low, e.g., too far below the surface 102 of the field 104, then too much dirt will be picked up with the row crop. Picking up too much dirt or digging too deeply into the surface, can damage the harvester 140 and the header 150 and increase the labor and cost of separating the produce 126A-H from the excess dirt. Conversely, if the header harvesting height 155 is too high, then some low lying portions of the row crop may be missed and the overall row crop yield is reduced.

As the header 150 approaches the upward graded portion 152A, the header will dig too deeply into the surface 102. As the header 150A passes down the downward graded portion 152B, the header will dig too deeply into the surface 102. As the header 150B passes over the crest of the upward graded portion 152A, the header will be too high above the surface 102 and the crop in the area 156 below the header will not be harvested by the header. It is in this context that the following embodiments arise.

### SUMMARY

Broadly speaking, the present disclosure fills these needs by providing a system, method and apparatus for differentiating between plants and the surface the plants are growing from and measuring the distance to the surface and using the measured distance to adjust a harvester header height to a desired harvesting height to provide an optimum harvest yield. It should be appreciated that the present disclosure can be implemented in numerous ways, including as a process, an apparatus, a system, computer readable media, or a device. Several inventive embodiments of the present disclosure are described below.

One implementation includes a sensor array capable of scanning a surface. Multiple plants are growing out of the surface at varying heights, densities, shapes, sizes and contours. The plants can include stems, vines, leaves and produce. The plants cover most of the surface. The sensor array outputs scanning data to a differentiating system. The differentiating system differentiates the portion of the surface that is not covered by the plants from the plants and outputs differentiating data to a distance calculating system. The distance calculating system determines a distance between the sensor array and the portion of the surface that is not covered by the plants. The distance calculating system outputs the distance from the distance calculating system to a header height control system. The header height control system adjusts the height of the header to a desired harvesting height relative to the surface.

The sensor array can include multiple lasers. Each of the lasers is capable of emitting a laser pulse between about 10 times per second to about 100,000 times per second or more. The sensor array can include between about 3 and about 10 sensors. The sensor array can be mounted proximate to a leading portion of the header.

The desired harvesting height relative to the surface can be above the surface or below the surface. The header height control system is capable of adjusting the height of the header to the desired harvesting height to compensate for variations in the surface. The surface variations can include rises, dips, ruts, cracks and other variations. The header height control system is capable of determining whether or not to adjust the height of the header to the desired harvesting height between less than about 1 time per second and about 10,000 times per second.

Another implementation provides a method of differentiating plants from a surface the plants are growing out of. The method includes scanning the surface with a sensor array. Multiple plants are growing out of the surface at varying heights, densities, shapes, sizes and contours. The plants can include stems, vines, leaves and produce. The plants cover most of the surface. The sensor array outputs scanning data to a differentiating system. The scanning data is used in the differentiating system to differentiate a portion of the surface that is not covered by the plants from the plants. The differentiating system also outputs differentiating data to a distance calculating system. The distance calculating system uses the differentiating data to determine a distance between the sensor array and the portion of the surface that is not covered by the plants. The distance calculating system outputs the distance to a header height control system. The header height control system uses the distance to adjust the height of the header to a desired harvesting height relative to the surface.

Another implementation provides a harvesting system including a harvester having a header, a header controller and a header height control system. The harvesting system is capable of adjusting a height of the header to a desired harvesting height as the header harvests plants growing in a surface. The harvesting system is capable of adjusting a height of the header multiple times each second to compensate for variations in the surface.

Other aspects and advantages of the disclosure will become apparent from the following detailed description, taken in conjunction with the accompanying drawings, illustrating by way of example the principles of the disclosure.

### BRIEF DESCRIPTION OF THE DRAWINGS

The present disclosure will be readily understood by the following detailed description in conjunction with the accompanying drawings.

FIGS. 1A and 1B include overhead views and corresponding side views of multiple row crops.

FIG. 1C illustrates a typical row crop field.

FIG. 1D is a profile view of the second portion of the field.

FIG. 2A is a simplified schematic of a harvester system for harvesting a tomato crop, for implementing embodiments of the present disclosure.

FIG. 2B is a simplified schematic of the harvester, for implementing embodiments of the present disclosure.

FIG. 3A is a side view of a surface of a field with irregular surface contour, for implementing embodiments of the present disclosure.

FIG. 3B is a flowchart diagram that illustrates the method operations performed in maintaining the harvester header at a desired height for harvesting, for implementing embodiments of the present disclosure.

FIG. 4A is a block diagram of the header height control system, for implementing embodiments of the present disclosure.

FIG. 4B is a block diagram of the header controller, for implementing embodiments of the present disclosure.

FIG. 4C is a piping and instrumentation diagram of the header height adjustment mechanisms, for implementing embodiments of the present disclosure.

FIG. 5A is a simplified top isometric view of the header, for implementing embodiments of the present disclosure.

FIG. 5B is a simplified front, bottom isometric view of the header, for implementing embodiments of the present disclosure.

FIG. 5C is a simplified rear, bottom isometric view of the header, for implementing embodiments of the present disclosure.

FIG. 5D is a simplified bottom schematic view of the header, for implementing embodiments of the present disclosure.

FIG. 5E is a simplified bottom schematic view of the header, with a single sensor, for implementing embodiments of the present disclosure.

FIG. 5F is a simplified bottom schematic view of an alternative, scanning single sensor, for implementing embodiments of the present disclosure.

FIGS. 6A-G are simplified views of the sensor array, for implementing embodiments of the present disclosure.

FIGS. 7A-D are simplified views of the sensor and the sensor mounting bracket, for implementing embodiments of the present disclosure.

FIG. 7E is a partially exploded view of an alternative sensor array, for implementing embodiments of the present disclosure.

FIGS. 7F-I are simplified views of the sensor and an alternative sensor mounting bracket, for implementing embodiments of the present disclosure.

FIGS. 8A-C are detailed views of the sensor openings in the sensor array housing, for implementing embodiments of the present disclosure.

FIG. 8D is a top view of a sensor array housing with the top cover removed, for implementing embodiments of the present disclosure.

FIG. 8E is a bottom view of a sensor array housing, for implementing embodiments of the present disclosure.

FIG. 9A is a piping and instrumentation diagram of a pressurized gas system for delivering pressurized gas to the sensor array housing, for implementing embodiments of the present disclosure.

FIG. 9B is a flowchart diagram that illustrates the method operations performed, in clearing the window, for implementing embodiments of the present disclosure.

FIG. 9C is a sectional view of the sensor opening in a portion of the sensor array housing, for implementing embodiments of the present disclosure.

FIG. 10 is a flowchart diagram that illustrates an overview of the method operations performed, in determining and adjusting the height for the header during harvester operations, for implementing embodiments of the present disclosure.

FIG. 11 is a flowchart diagram that illustrates a more detailed view of the method operations performed, in determining and adjusting the height for the header during harvester operations, for implementing embodiments of the present disclosure.

FIG. 12 is a more detailed flowchart diagram that illustrates the method operations performed, in calculating the standard deviation height for the header, for implementing embodiments of the present disclosure.

FIG. 13 is a simplified block diagram of multiple automatic systems that can interact during harvester operations, for implementing embodiments of the present disclosure.

### DETAILED DESCRIPTION

Several exemplary embodiments for an improved harvester header control system will now be described. It will be apparent to those skilled in the art that the present disclosure may be practiced without some or all of the specific details set forth herein.

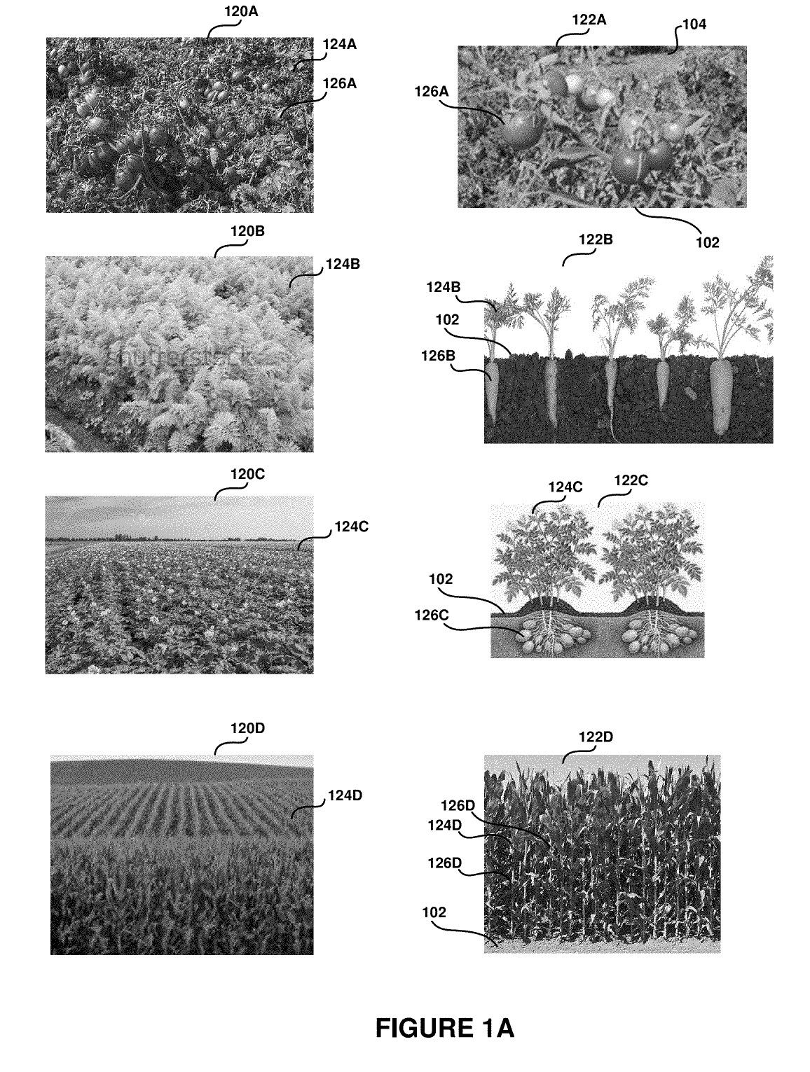

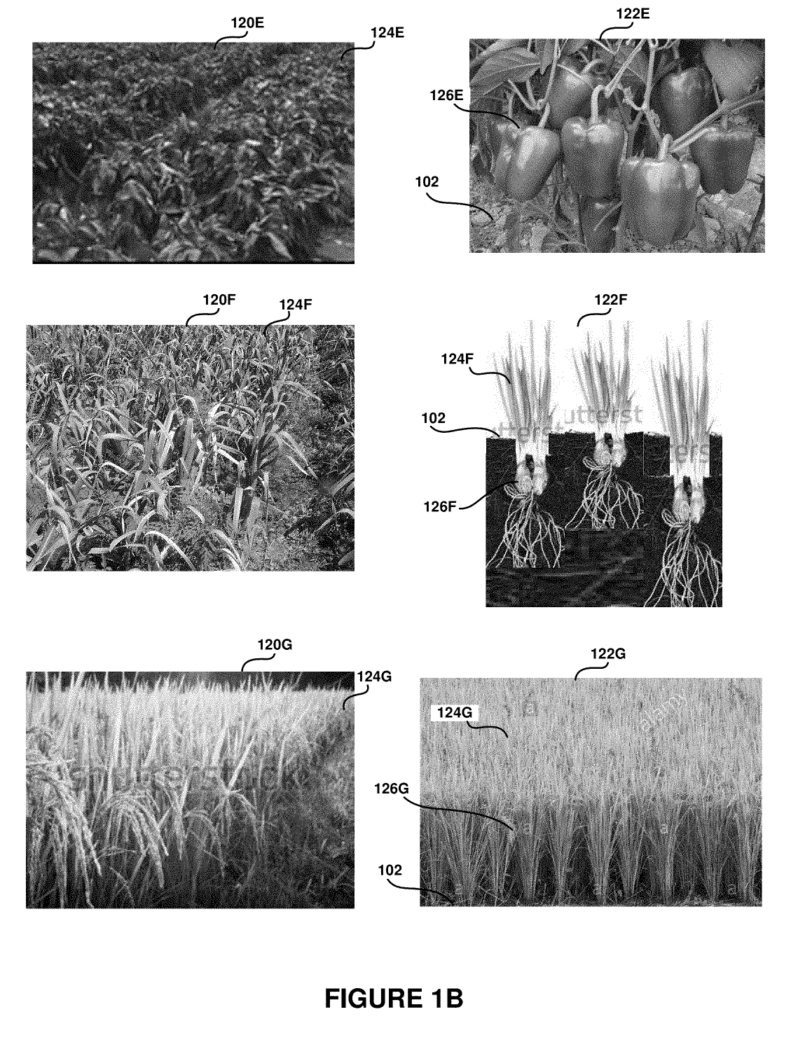

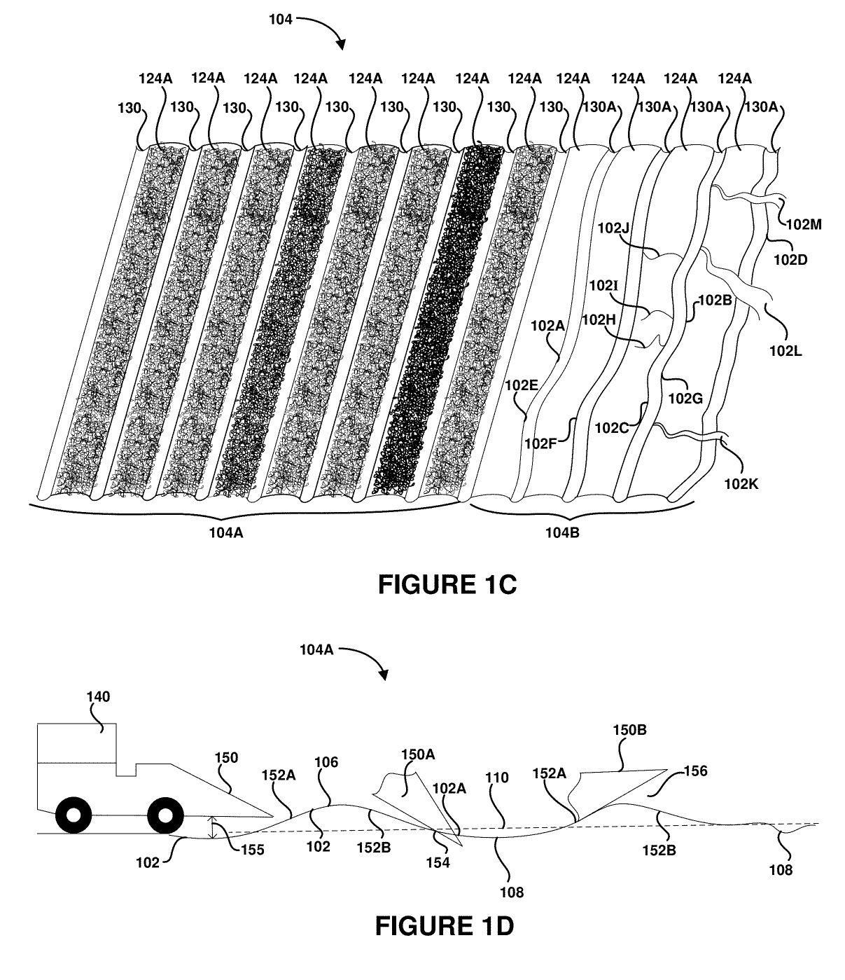

Controlling the header harvesting height 155, as shown in FIGS. 1C and 1D, is challenging due to the many different surface variations 102A-M, 106, 108, 152A and 152B that occur in the field 104. If the header harvesting height 155 is too high, then some low lying portions of the row crop may be missed and the overall row crop yield is reduced. In the instance of subterranean row crop produce such as onions, potatoes, garlic, carrots and similar produce, the desired header height 155 must be sufficiently and consistently deep enough below the surface 102 of the field to harvest substantially all of the subterranean row crop produce. In a subterranean row crop produce the desired header height 155 is sufficiently and consistently about 25 mm deeper than the deepest expected subterranean row crop produce.

In the instance of row crop produce lying on or near the surface 102 such as tomatoes, cucumbers, peppers and similar produce, the desired header height 155 can be slightly below the surface 102, e.g., less than about 25 mm below the surface, of the field 104 to successfully harvest substantially all of the produce on the surface. In the instance of row crop produce above the surface 102 such as some tomatoes, peppers, corn, wheat, rice and similar produce, the desired header height 155 must be slightly below the level of the lowest produce, e.g., less than about 25 mm below the lowest expected row crop produce, to successfully harvest substantially all of the produce. In implementations for a more sub-surface produce such as onions, garlic, carrots and potatoes, the desired header height can be set to between about 10 mm and about 50 mm below the lowest level of the sub-surface produce.

Maintaining the desired header height 155 is challenging due to the many different surface variations 102A-M, 106, 108, 152A and 152B that occur in the field 104 as the harvester moves across the field. The following implementations are described using a tomato harvesting system, however, it should be understood that the system described herein for controlling the header height for the tomato harvesting system can be utilized for many other subterranean and surface crops such as onions, potatoes, garlic, carrots cucumbers, peppers, corn, wheat, rice and other suitable crops.

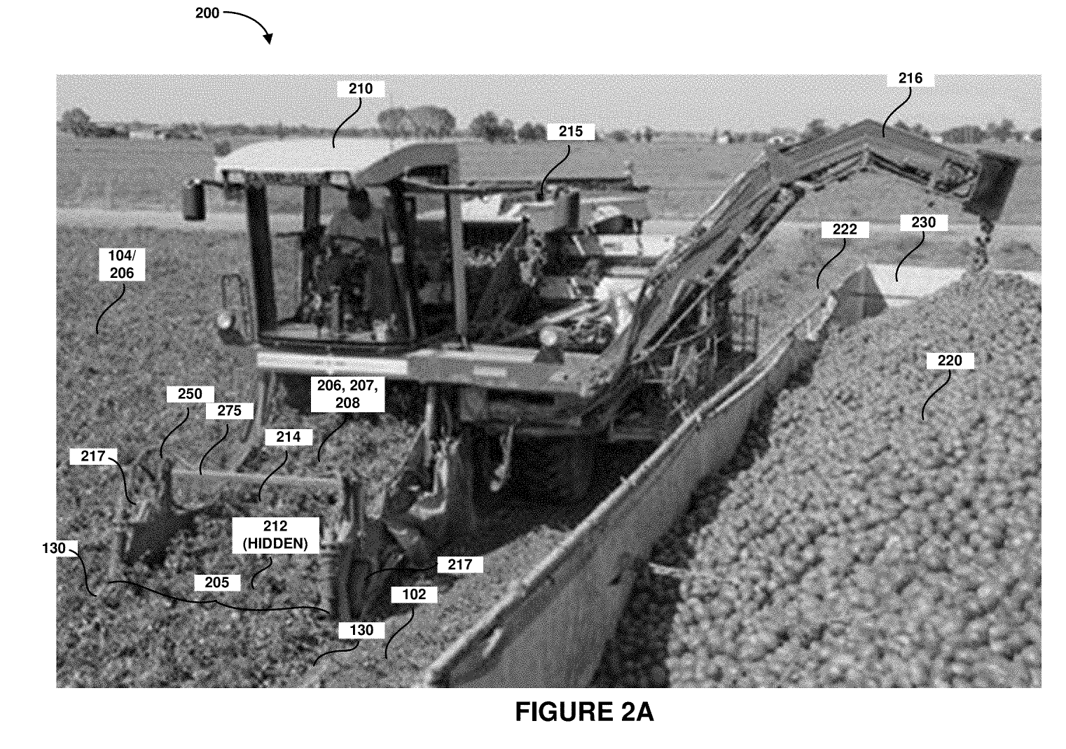

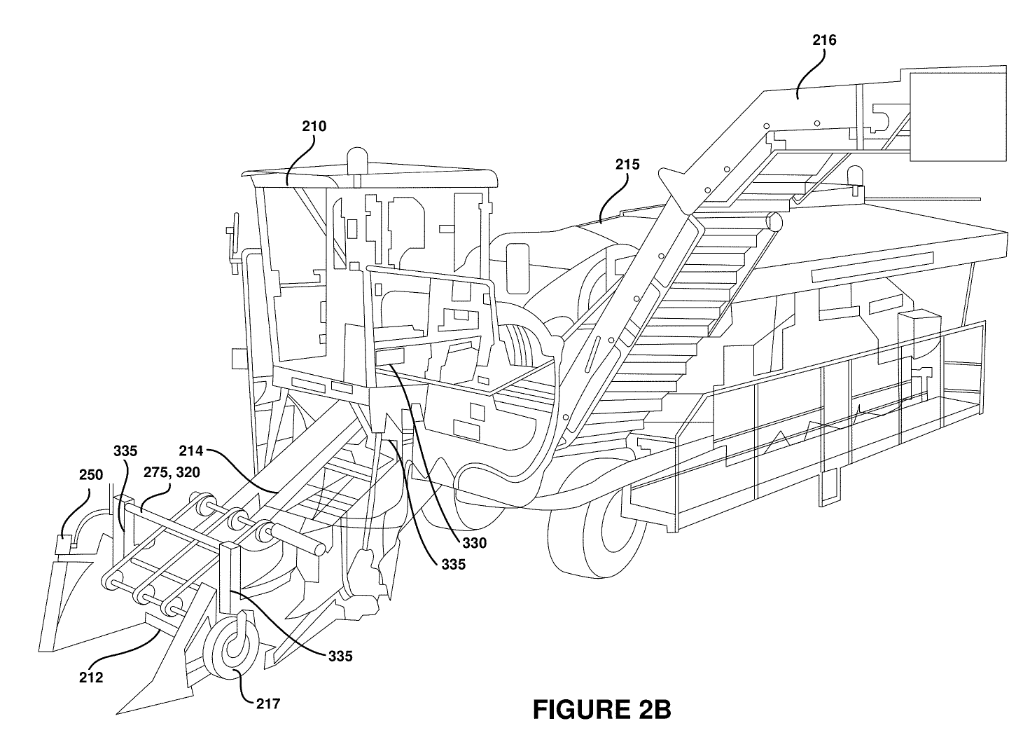

FIG. 2A is a simplified schematic of a harvester system 200 for harvesting a tomato crop, for implementing embodiments of the present disclosure. The harvester system 200 includes a harvester 210 and a transport vehicle 230 for transporting the harvested crop 220. The harvester 210 is shown in a field 104 of tomato plants 206 in the process of harvesting a row 205 of tomato plants 206.

FIG. 2B is a simplified schematic of the harvester 210, for implementing embodiments of the present disclosure. The harvester 210 includes a header 250, a separator system 215 and a delivery arm 216. The header 250 includes a blade 212, wheels 217, a header conveyor 214 and a support bar 275. The wheels 217 can travel across the field 104 in optional furrows 130. In at least one implementation, the support bar 275 includes a sensor array 320 as described in more detail below. The sensor array 320 is coupled to a header controller 330. The header controller 330 is coupled to header height adjustment mechanisms 335 capable of raising and lowering the header 250. The header height adjustment mechanisms include one or more pneumatic, hydraulic or electromotive devices and corresponding controlling valves and circuits.

The header blade 212 cuts the tomato plants at about equal to or slightly below the level of the surface 102 of the field 104. As a result, the majority of the tomato plants 206, a quantity of dirt 207 and a majority of the tomatoes 208 are harvested from the row 205.

The separator system 215 separates the tomatoes 208 from a first portion of the tomato plants 206A and a first portion of the quantity of dirt 207A. The first portion of the tomato plants 206A and the first portion of the quantity of dirt 207A are dispensed out of the harvester 210 and deposited on the surface of the field 222. The delivery arm delivers the tomatoes 208, a second portion of the tomato plants 206B and a second portion of dirt 207B to the transport vehicle 230 as the harvested crop 220.

The height of the header blade 212 determines how large or small the quantity of dirt 207 that is picked up with the tomato plants 206 and tomatoes 208. The quantity of dirt 207 that is picked up with the tomato plants 206 and tomatoes 208 increases when the height of the header blade 212 is too far below the surface 102 of the field 104. Conversely, the quantity of dirt 207 and the quantity of tomatoes 208 that is picked up with the tomato plants 206 decreases when the height of the header blade 212 is too far above the surface 102 of the field 104.

The harvester 210 can also include a dirt gap system for separating the first portion of the dirt from the produce. The dirt gap system passes the harvested produce and dirt across an adjustable gap. As the harvested produce in the dirt pass across the dirt gap, first portion of the dirt and a first portion of the produce passes through the dirt gap while a second portion of the dirt and a second portion of the produce pass across the dirt gap. The dirt gap system also includes a monitoring system quantifying the produce passing through the dirt gap. If too much produce passes through the dirt gap, then the dirt gap is reduced. However, if the dirt gap is reduced too much, then excessive quantities of dirt are passed through with the produce and must be removed during processing of the produce. Excessive dirt mixed with the produce reduces the yield, increases the tonnage of produce and dirt removed from the field, and increases the cost of processing the produce. An ideal dirt gap would cause all of the dirt to pass through the dirt gap and none of the produce to pass through the dirt, however the dirt gap is rarely ideal. As will be described in more detail below, there are automated systems to attempt to maintain the dirt gap as close to an ideal dirt gap as possible.

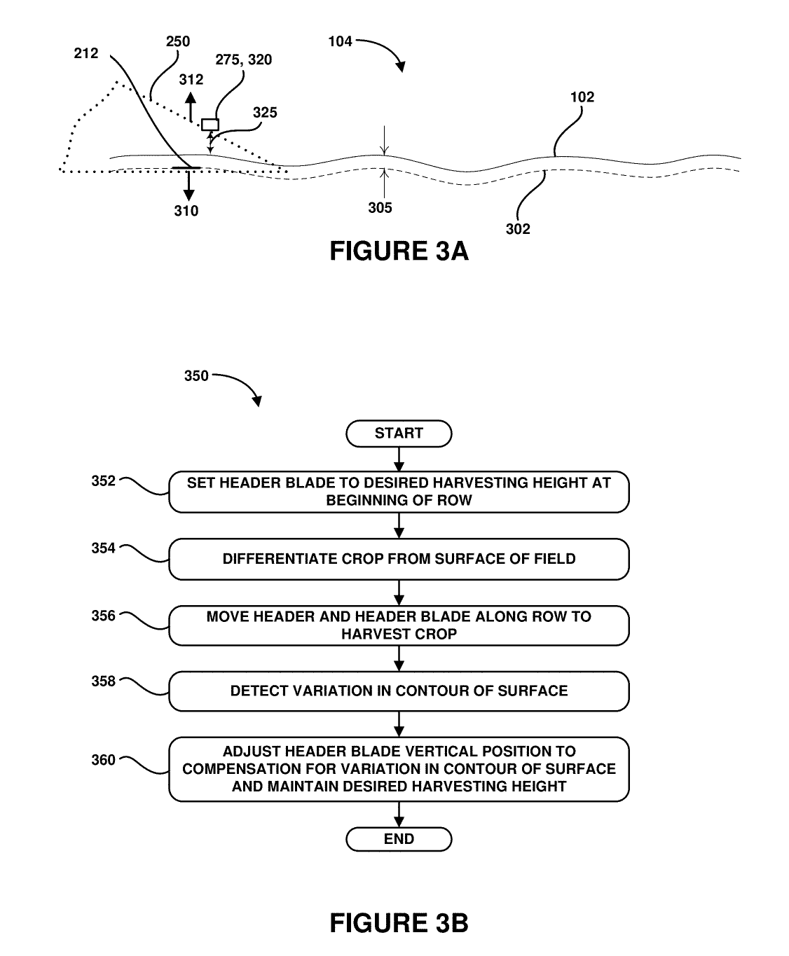

FIG. 3A is a side view of a surface 102 of a field 104 with irregular surface contour, for implementing embodiments of the present disclosure. The header 250 can be adjusted in upward direction 312 and downward direction 310 to adjust the height of the header blade 212. The surface 102 has the irregular surface contour as illustrated. The desired harvesting height 305 that is offset below the surface 102 for a tomato crop. A desired harvesting height for tomatoes is between about 0 mm and 30 mm below the surface 102. As the header blade moves across the field 104, the sensor array 320 emits a measuring beam 325 to measure the distance between the sensor array and the surface 102.

FIG. 3B is a flowchart diagram that illustrates the method operations 350 performed in maintaining the harvester header at a desired height for harvesting, for implementing embodiments of the present disclosure. The operations illustrated herein are by way of example, as it should be understood that some operations may have sub-operations and in other instances, certain operations described herein may not be included in the illustrated operations. With this in mind, the method and operations 350 will now be described.

In an operation 352, the header 250 is aligned at a starting point in the field 104 and the header blade 212 is adjusted to a desired harvesting height 305 relative to the surface 102. In one implementation, the header blade 212 can be adjusted to the desired harvesting height 305 manually by an operator of the harvester. In other implementations, the header blade 212 can be adjusted to the desired harvesting height 305 automatically by a header controller 330 as will be described in more detail below.

In an operation 354, the sensor array 320 emits a measuring beam 325 toward the surface 102. The measuring beam 325 can be a laser light emission emitted from the sensor array and that is reflected off the plants, produce and the surface 102, in at least one implementation. The reflected laser light emission is received in the sensor array 320 and the corresponding reflected laser light data values are input to the header controller 330. The reflected laser light data values can be processed by the header controller 330 to differentiate the surface 102 from the plants and produce. In other implementations the measuring beam 325 can include receiving an image of the plants, produce and the surface 102 in the area within an optical range of the sensor array 320. The image is received in the sensor array 320 and the corresponding image data values are input to the header controller 330. The image data values can be processed by the header controller 330 to differentiate the surface 102 from the plants, produce. Differentiating between the surface 102 and the plants and produce includes determining a distance between the surface 102 and the sensor array 320.

In an operation 356, the header 250 and header blade 212 are moved along the row 205 to harvest the plants and produce as the harvester 210 is moved across the field 104. As the harvester 210 moves across the field, the sensor array 320 continues to emit a laser light emission 325 and receive reflected laser light in an operation 358. The received reflected laser light data values can be processing the header controller to detect variations in the contour of the surface 102.

In an operation 360, the header blade 212 is adjusted in directions 310 and/or 312 to compensate for the detected variations in the contour of the surface 102 to maintain the desired harvesting height with the header height adjustment mechanisms 335. As a result, the header blade 212 follows the contour of the surface 102, offset the desired harvesting height 305.

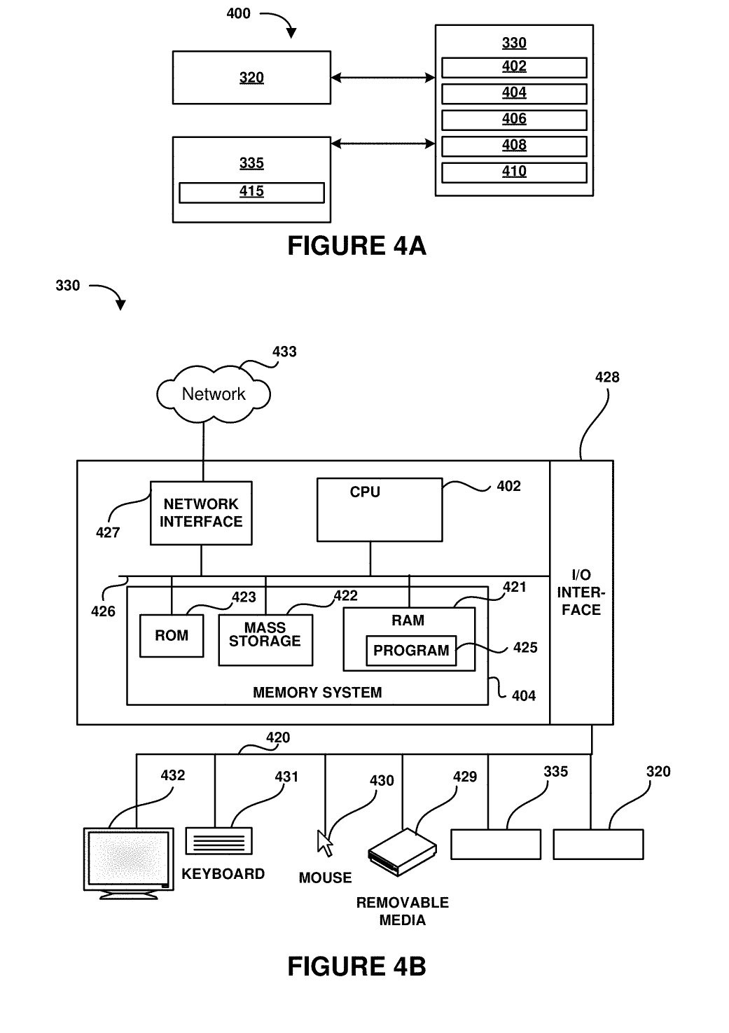

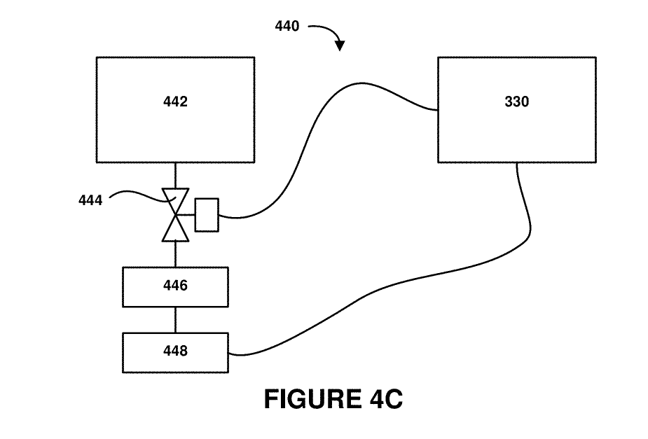

FIG. 4A is a simplified block diagram of the header height control system 400, for implementing embodiments of the present disclosure. The header height control system 400 includes the sensor array 320 coupled to the header controller 330. The header controller 330 is also coupled to the header height adjustment mechanisms 335. The header height adjustment mechanisms 335 can include at least one header height feedback device capable of providing header position information to the header controller 330.

The header controller 330 includes a central processing unit 402, a memory system 404, a differentiating system 406, a distance calculating system 408 and a header controller 330 coupled by a data bus. The differentiating system 406 includes processing logic software and hardware for analyzing data received from the sensor array to differentiate between the surface 102 and the plants and produce present between the surface and the sensor array.

The distance calculating system 408 receives the differentiating data from the differentiating system 406 and calculates the distance between the sensor array 320 and the surface 102 of the field 104. The position of the sensor array 320 on the header is known and therefore the height of the header 250 can be determined from the distance between the sensor array and the surface 102 of the field 104.

The header controller 330 is coupled to the header height adjustment mechanisms 335. The header controller 330 receives the distance information from the distance calculating system 408, compares the received distance information to the current header height, determines any header height correction and outputs a corresponding header height correction signal to the header height adjustment mechanisms 335.

FIG. 4B is a block diagram of the header controller 330, for implementing embodiments of the present disclosure. The header controller 330 can include a general or specialized computer system. The header controller 330 includes a central processing unit 402, memory system 404, I/O interface 428, and interconnecting data bus 426. The interconnecting data bus 426 provides data communications between each of the different components and subsystems of the header controller 330.

The header controller 330 can include optional user interface devices including a display screen 432, a keyboard 431, a mouse 430, or similar pointing device, and a removable media (e.g., magnetic/optical/flash) drive 474. The header controller 330 can include optional network connectivity in the form of a network interface 427 for connecting to one or more wired or wireless networks 433. The memory system 404 includes a mass storage device (e.g., hard disk drive or solid state drive or other suitable storage device) 422, random access memory (RAM) 421 and read only memory (ROM) 423. The header controller 330 can be a personal computer (such as an IBM compatible personal computer, a Macintosh computer or Macintosh compatible computer), a workstation computer (such as a Sun Microsystems or Hewlett-Packard workstation), or some other suitable type of computer or a special purpose computer.

The CPU 402 can be a general purpose digital processor or a specially designed processor. The CPU 402 controls the operation of the header controller 330. The CPU controls the reception and manipulation of input data and the output and display of data on output devices using instructions in the form of computer programs 425 that are retrieved from the memory system 404 and executed. The combination of the CPU 402, computer programs 425 and other logic devices can form the differentiating system 406, the distance calculating system 408 and the header controller 330.

The interconnecting data bus 426 is used by the CPU 402 to access the memory system 404. The RAM 421 is used by the CPU 402 as a general storage area and as scratch-pad memory and can also be used to store input data and processed data. The RAM 421 and the ROM 422 can be used to store computer readable instructions or program code readable by the CPU 402 as well as other data.

A peripheral bus 420 is used to access the input, output, and storage devices used by the header controller 330. These devices include the display screen 432, the removable media drive 429, mouse 430 and the keyboard 431. The sensor array 320 and/or the header height adjustment mechanisms 335 can be connected to the peripheral bus 420 and/or other input output interface to the header controller 330. The input/output device 428 is used to receive input from devices connected to the peripheral bus 420 and send corresponding decoded data to and from the CPU 402 over the interconnecting data bus 426.

The display screen 432 is an output device that displays images of data provided by the CPU 402 via the peripheral bus 420 or provided by other components in the header controller 330.

The removable media drive 429 can be used to store various types of data and provide access to deliver data and software programs to the header controller 330. The removable media drive 429 facilitates transporting such data to and from other computer systems. The mass storage device 422 permits fast access to large amounts of stored data. The mass storage device 422 may be included within the header controller 330 or may be external to the header controller such as network attached storage or cloud storage accessible over one or more networks 433 (e.g., local area networks, wide area networks, wireless networks, Internet) or combinations of such storage devices and locations.

The CPU 402 together with an operating system operate to execute computer readable code and logic and produce and use data. The computer code, logic and data may reside within the RAM 421, the ROM 423, or the mass storage device 422 or other media storage devices and combinations thereof. The computer code and data could also reside on a removable program medium and loaded or installed onto the header controller 330 when needed. Removable program media include, for example, DVD, CD-ROM, PC-CARD, floppy disk, flash memory, optical media and magnetic disk or tape.

The network interface 427 is used to send and receive data over a network 433 connected to other computer systems. An interface card or similar device and appropriate software implemented by the CPU 402 can be used to connect the header controller 330 to an existing network and transfer data according to standard protocols such as local area networks, wide area networks, wireless networks, Internet and any other suitable networks and network protocols.

The keyboard 431 can include a limited number of special purpose keys or buttons or a more expansive alpha-numeric keyboard and a virtual keyboard such as a touch screen or touch ad or similar input device. The keyboard 431 is used by a user to input commands and other instructions to the header controller 330. Other types of user input devices can also be used in conjunction with the present invention. For example, pointing devices such as a computer mouse, a track ball, a stylus, touch pad, touch screen or a tablet can be used to manipulate a pointer on a screen of a general-purpose computer.

FIG. 4C is a simplified piping and instrumentation diagram 440 of the header height adjustment mechanisms 335, for implementing embodiments of the present disclosure. The header height adjustment mechanisms 335 can be pneumatic, hydraulic or electronic or combinations thereof. In one implementation the header height adjustment mechanisms 335 are pneumatic or hydraulic and include at least one pressure source 442, at least one control valve 444, at least one header height actuator 446. The header height adjustment mechanisms 335 can optionally include at least one header height feedback sensor 448.

The control valve 444 and the optional header height feedback sensor 448 are coupled to the header controller 330. The header controller 330 outputs a control signal to the control valve 444 to couple pressure from the pressure source 442 to the header height actuator 446. Providing pressure to the header height actuator 446 causes the header height to change up or down. While only one control valve 444 is show, it should be understood that control valve 444 can include multiple control valves. By way of example, the control valve 444 can include a first control valve for raising the header height and a second control valve for lowering the header height. Similarly, header height actuator 446 can include two or more header height actuators. By way of example, the header height actuator 446 can include a first header height actuator for raising the header height and a second header height actuator for lowering the header height. Similarly, the header height actuator 446 can include header height actuators having different actuation accuracies or speeds. By way of example, the header height actuator may include a first header height actuator for raising and lowering the header height greater amounts and a second header height actuator for raising and lowering the header height lesser amounts to provide a more refined movement amount for fine adjustments the header height.

The header height feedback sensor 448 detects the change in header height and outputs a corresponding header height feedback signal to the header controller 330. The header height feedback signal provides an indication to the header controller 330 a quantity and direction of change in the header height. In other implementations, the header height feedback signal can be derived from the distance signal output from the distance calculating system 408.

In another implementation where the header height adjustment mechanisms 335 includes an electronic actuator, the header height actuator 446 can include an electromotive device such as an electronic armature or a stepper motor or similar electromotive device. The electromotive device can include an optional internal header height feedback sensor incorporated within the electronic armature or stepper motor. The electromotive device can also be used with the optional header height feedback sensor 448, as described above. The electromotive device may not require the pressure source 442 and alternatively may be coupled to an electrical power source. The header controller 330 can be coupled to the electromotive device for providing control signals to the electromotive device.

The at least one control valve 444 can include at least one bang-bang valve in at least one implementation. A bang-bang valve is also known as a directional valve or switching valve. The bang-bang valve responds to control signals from the header controller 330 with one of three operative states: off, on forward, on reverse. The bang-bang valve is a relatively simple hydraulic or pneumatic valve that, when activated, directs hydraulic or pneumatic pressure, at substantially full pressure, to a hydraulic or pneumatic actuator. As a result, large pressure waves and reverberations of the pressure waves can occur within the hydraulic or pneumatic actuator and the hoses coupling the bang-bang valve to the hydraulic or pneumatic actuator. Further, the full pressure can cause very rapid acceleration and movement of the hydraulic or pneumatic actuator.

In another implementation, the at least one control valve 444 can include at least one proportional valve. The proportional valve responds to a variable input control signal from the header controller 330 to output a corresponding proportional hydraulic or pneumatic pressure and flow to the actuator. The proportional valve thus moves the actuator more smoothly and with more control than the bang-bang valve. The proportional control provided by the proportional valve provides a more accurate adjustment of the header height in response to the control signal from the header controller 330.

In another implementation, the at least one control valve 444 can include at least one servo valve. Servo valves operational characteristics include a very high accuracy with a very high frequency response and with a very low hysteresis, as compared to proportional valves and bang-bang valves. The servo valve operational characteristics provide a faster response to control signals than the proportional valve, thus allowing the header controller 330 to more quickly and accurately adjust the height of the header. A quicker and more accurate height adjustment of the header provides a higher yield of the harvest and with less wear and tear on the harvester.

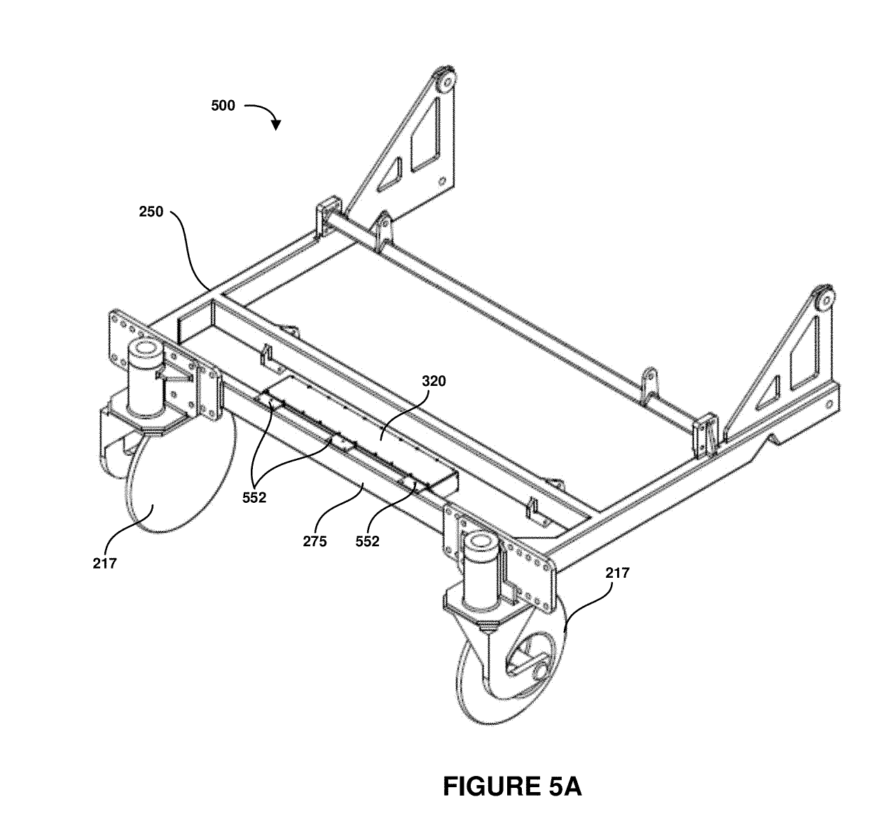

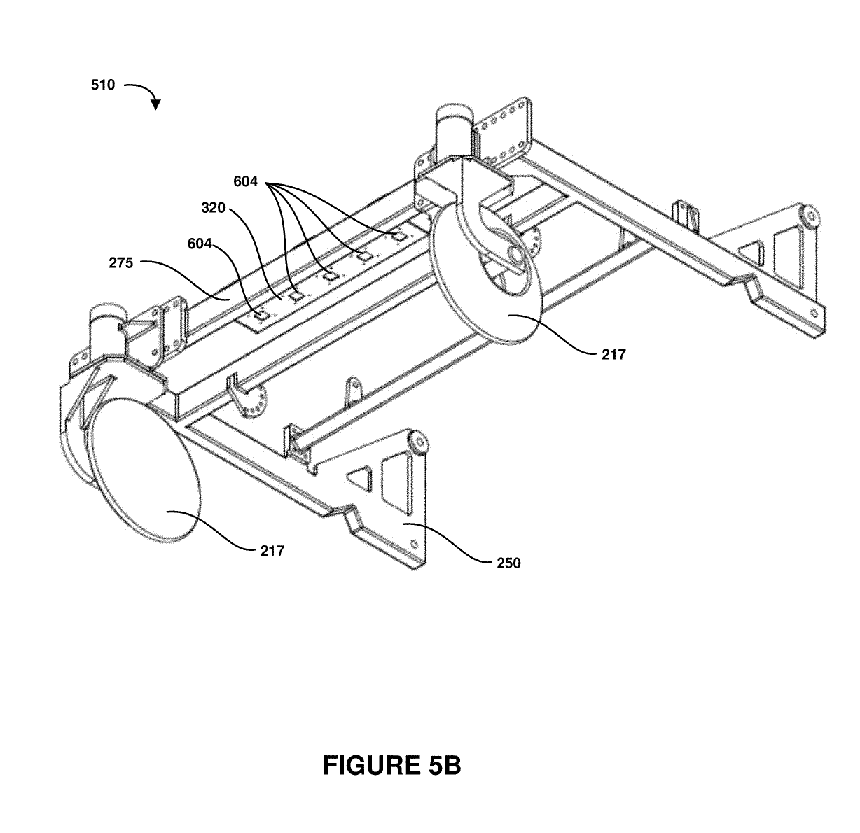

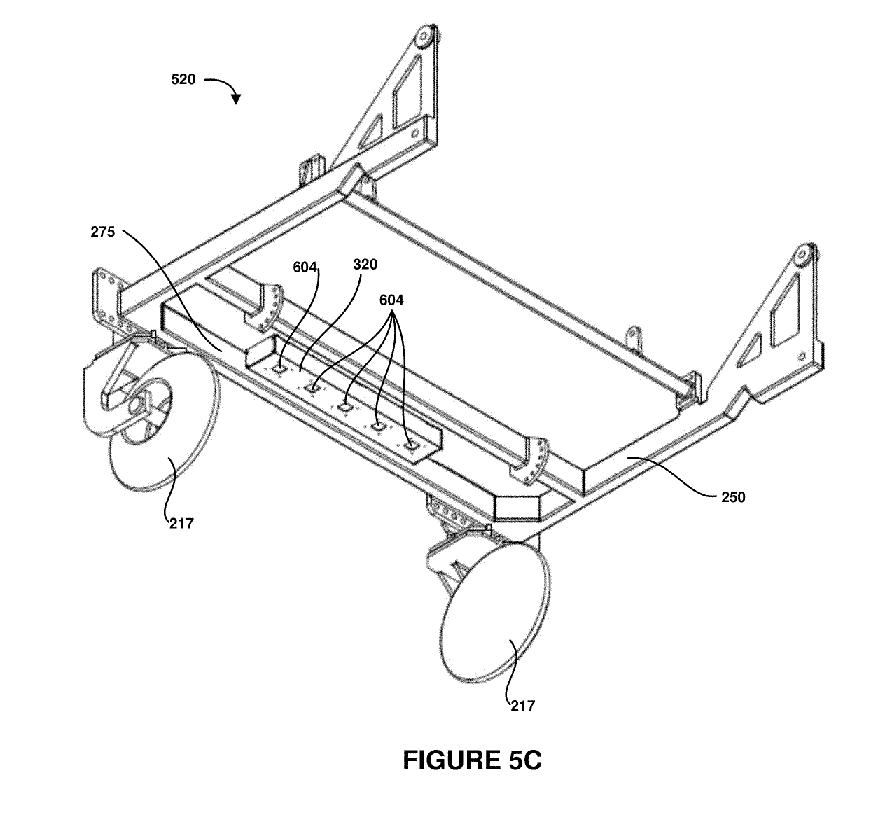

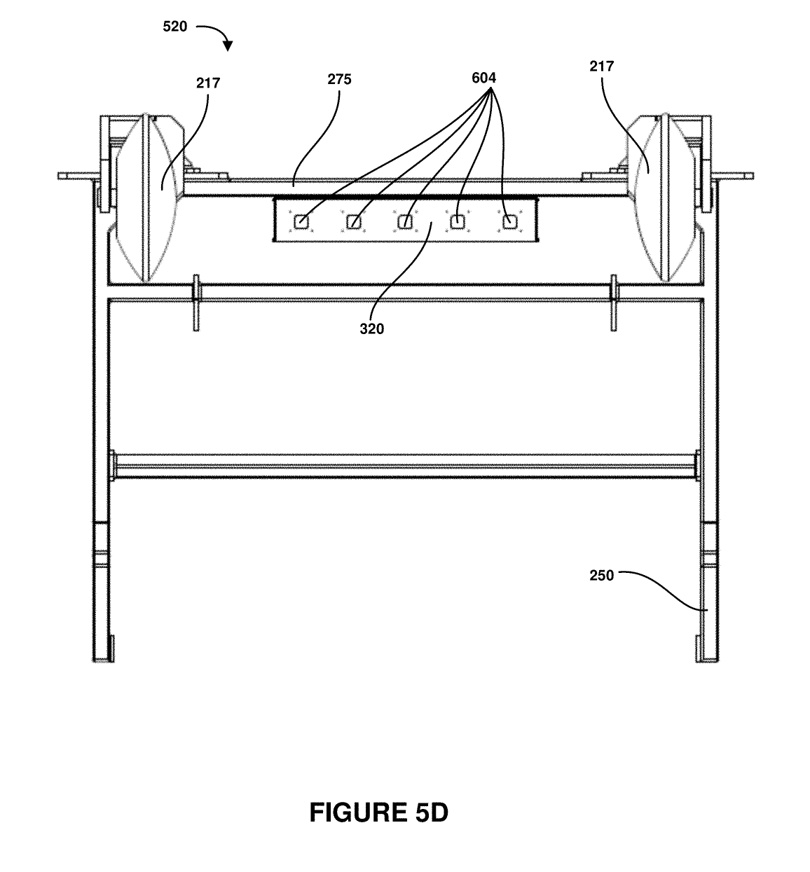

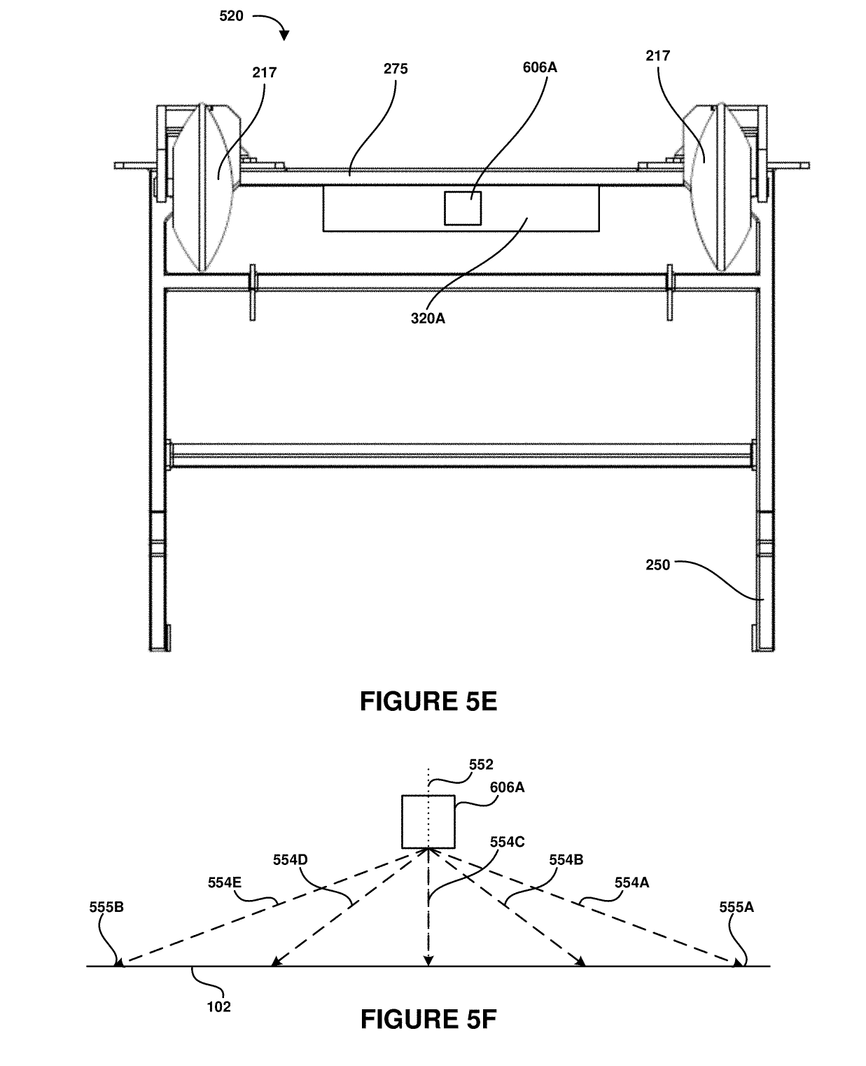

Figure SA is a simplified top isometric view 500 of the header 250, for implementing embodiments of the present disclosure. FIG. 5B is a simplified front, bottom isometric view 510 of the header 250, for implementing embodiments of the present disclosure. FIG. 5C is a simplified rear, bottom isometric view 520 of the header 250, for implementing embodiments of the present disclosure. FIG. 5D is a simplified bottom schematic view 530 of the header 250, for implementing embodiments of the present disclosure. The header 250 includes the wheels 217, the support bar 275 and the sensor array 320. The sensor array 320 is mounted on the header 250 with multiple mounting tabs 552.

The sensor array 320 is shown with five sensors 606, however, it should be understood that the sensor array 320 can include as few as a single sensor or as many as 10 or more sensors. The number of sensors 606 is limited only by the desired cost, complexity and processing power of the header height controller 330. In one implantation, distributing multiple sensors 606 across a width of the row of crops being harvested provides a row width averaged distance to between the sensor array and the surface 102 of the field 104. The row width averaged distance allows for a more accurate measurement of the actual distance between the sensor array and the surface of the field.

The sensor array 320 is shown with the five sensors 606 being substantially centered and substantially evenly spaced across a portion of the width of a distance between the wheels 217. It should be understood that the sensors 606 can be unevenly spaced across the width of the sensor array 320 and that the sensor array can be offset to one side or the other of the width of a distance between the wheels 217.

FIG. 5E is a simplified bottom schematic view 530 of the header 250, with a single sensor 606A, for implementing embodiments of the present disclosure. The single sensor 606A can be similar to the sensors 606 described above. FIG. 5F is a simplified bottom schematic view of an alternative, scanning single sensor 606A, for implementing embodiments of the present disclosure. Alternatively, the single sensor 606A can be a scanning sensor capable of scanning an output laser beam across the width of the header to scan the contents of the row passing below the header. The single scanning sensor 606A can be used substantially similarly to the multiple sensors described herein as the distances measured by the scanning sensor can be captured as the laser scans across the row. In one exemplary implementation, scanning the laser +60 degrees from a vertical axis toward a first side (e.g., toward the right) causes the laser to scan to the corresponding first edge 555A (e.g., right edge) of the row. Similarly, scanning the laser −60 degrees from a vertical axis 552 to a second side (e.g., toward the left) causes the laser to scan to the corresponding second edge 555B (e.g., left edge) of the row, where the second edge of the row is opposite from the first edge of the row. To simulate five separate sensors, the distance value measured by the scanning laser can be captured at −60 degrees 554E, −30 degrees 554D, 0 degrees 554C, +30 degrees 554B and +60 degrees 554A from the vertical axis 552. Each of the distance values can then be determined using a trigonometric calculation to determine a vertical distance between the sensor 606A and the surface 102 of the field. Similarly, the scanning sensor 606A can simulate a multitude of sensors by measuring the distance values at corresponding number of degree intervals along the scan between the right side 555A and the left side 555B of the row. In at least one implementation, the degree intervals between each distance measuring value can be evenly spaced degree intervals. In another implementation, the degree intervals between each distance measuring value can be unevenly spaced degree intervals. In at least one embodiment, the scanning sensor 606A can be used in combination with one or more non-scanning sensors 606.

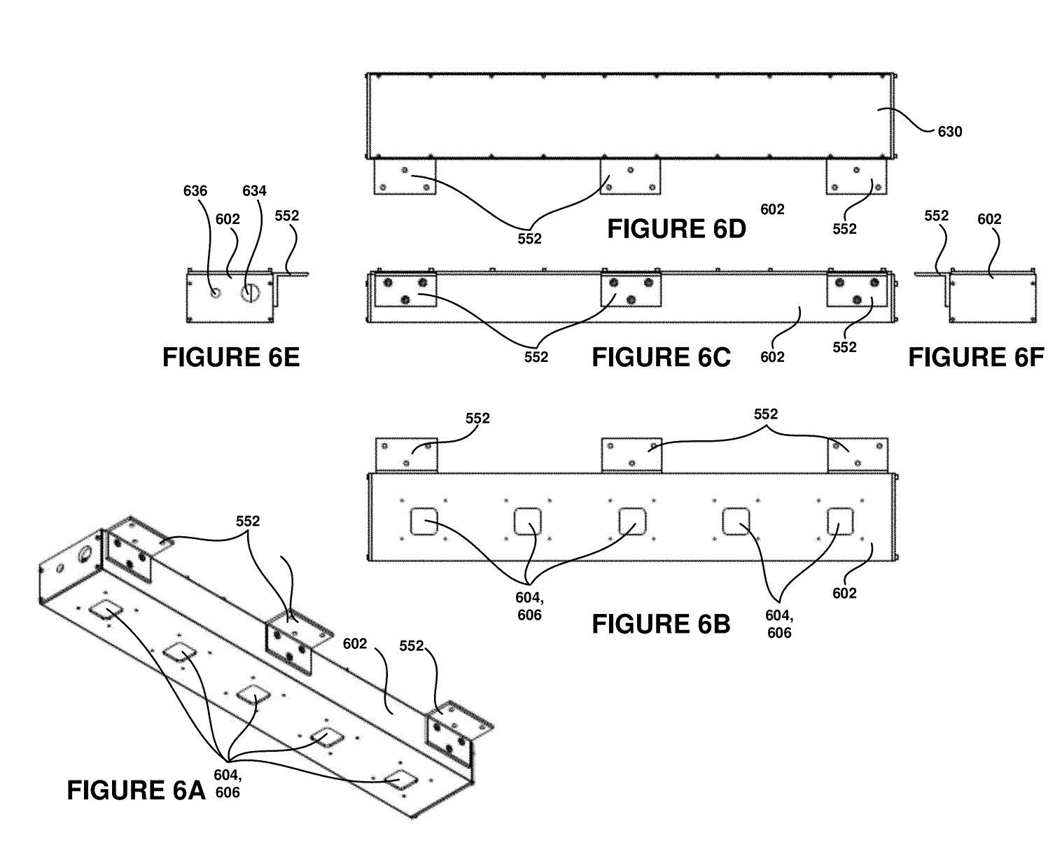

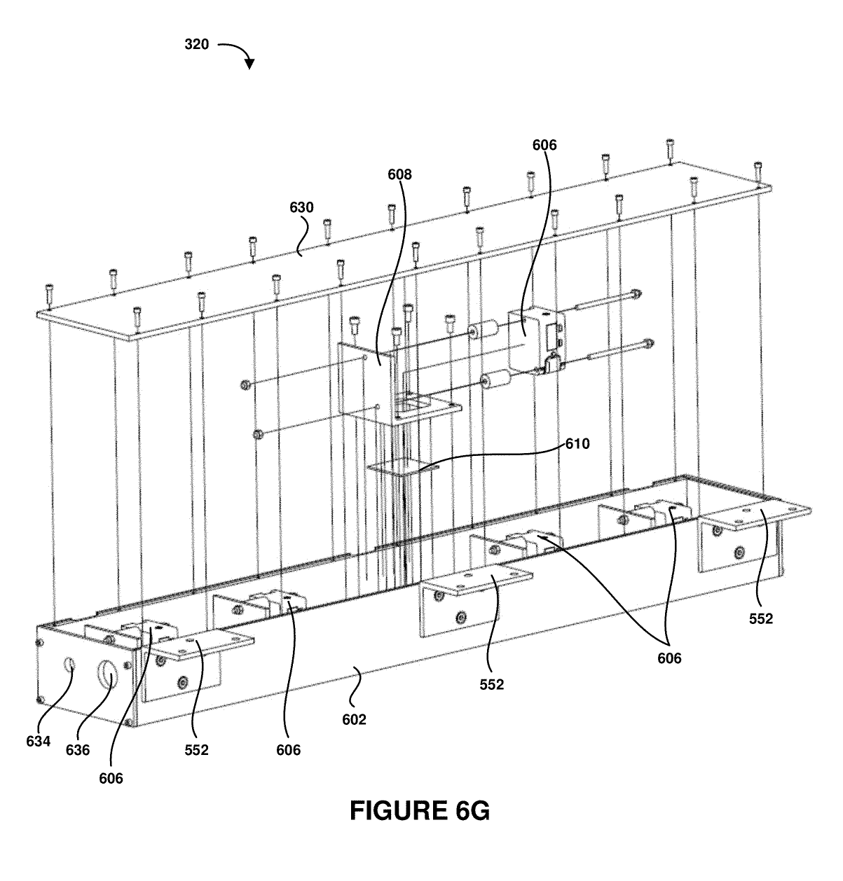

FIGS. 6A-F are a simplified views of the sensor array 320, for implementing embodiments of the present disclosure. FIG. 6A is a bottom, isometric view of the sensor array 320. FIG. 6B is a bottom view of the sensor array 320. FIG. 6C is a front view of the sensor array 320. FIG. 6D is a top view of the sensor array 320. FIG. 6E is a right end view of the sensor array 320. FIG. 6F is a left end view of the sensor array 320. FIG. 6G is a partially exploded view of the sensor array 320. The sensor array 320 includes a sensor array housing 602. The sensor array housing 602 includes multiple sensor openings 604. The sensor array housing 602 can be formed from metal, such as aluminum, ferrous metals, non-ferrous metals, alloys of aluminum and/or ferrous metals and/or non-ferrous metals and combinations thereof. The sensor array housing 602 can be formed from plastics, fiberglass, ceramics and other composite materials and combinations thereof.

One or more sensors 606 are mounted in each of the sensor openings 604. The sensors 606 are mounted in the sensor array housing 602 by a sensor mounting bracket 608. The sensor 606 is mounted to the sensor mounting bracket 608 by any suitable means. The sensor mounting bracket 608 is mounting in the sensor array housing 602 by any suitable means. The suitable means of mounting the sensor 606 and the sensor mounting bracket 608 can include mechanical fasteners such as screws, bolts, rivets, adhesives, welding, and combinations thereof. The sensor mounting bracket 608 can be formed from any suitable material such as ferrous and non-ferrous metals, composites, plastics and combinations thereof.

In at least one implementation, an optional sensor window 610 is secured in each of the multiple sensor openings 604 of the sensor array housing 602. The optional sensor window 610 protects the sensor 606 from dirt, debris, moisture and other contaminants from the field. The sensor array housing 602 includes a signal access port 636 for signal and control wiring between the sensors 606 and the header controller 330 (shown in FIG. 2B).

The sensor array housing 602 includes an access panel 630 which provides access to the internal components in the sensor array 320. The access panel 630 is secured to the sensor array housing 602 by any suitable means. As shown herein, the access panel 630 is secured with multiple mechanical fasteners, however, it should be understood that adhesives, sealants, clamps, welding and many other permanent and temporary type fastening systems could be used. The sensor array housing 602 can be formed from any suitable material including ferrous and non-ferrous metals, composites, plastic, and any combinations thereof.

The sensor array housing 602 can include a seal 632 to substantially seal the access panel 630 to the sensor array housing. In at least one implementation, the sensor array housing 602 and/or the sensors 606 can be substantially air tight so as to be capable of being pressurized through a pressure port 634 to a pressure greater than ambient, atmospheric pressure, as will be described in more detail below.

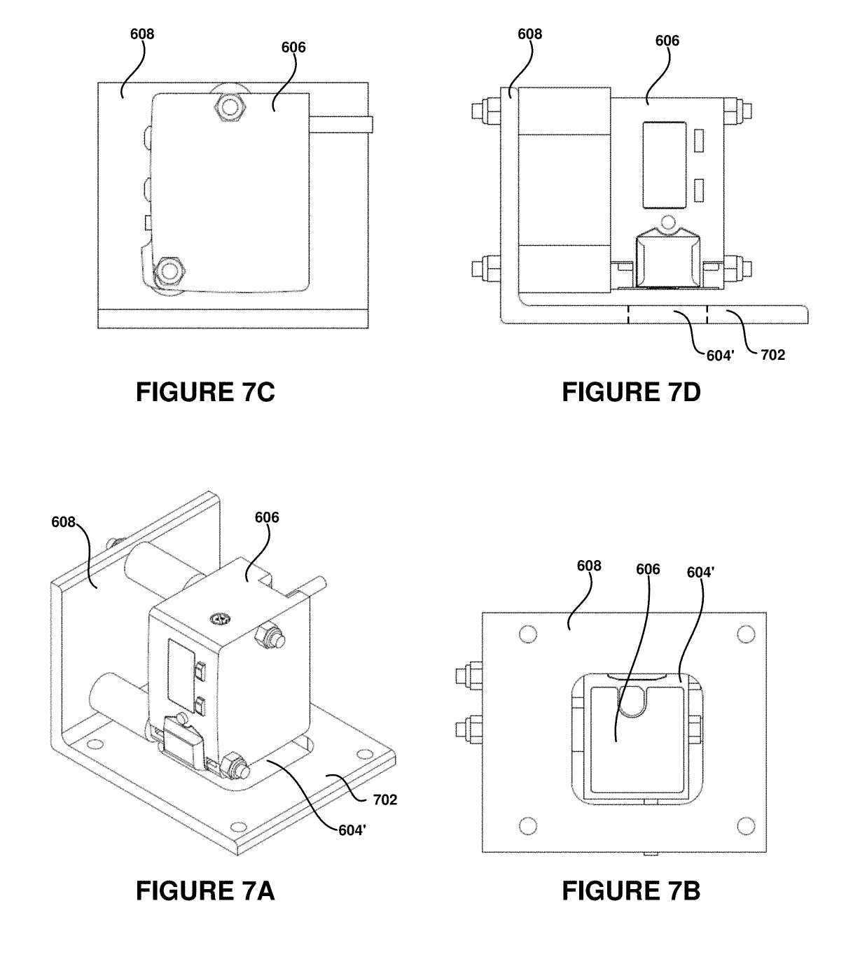

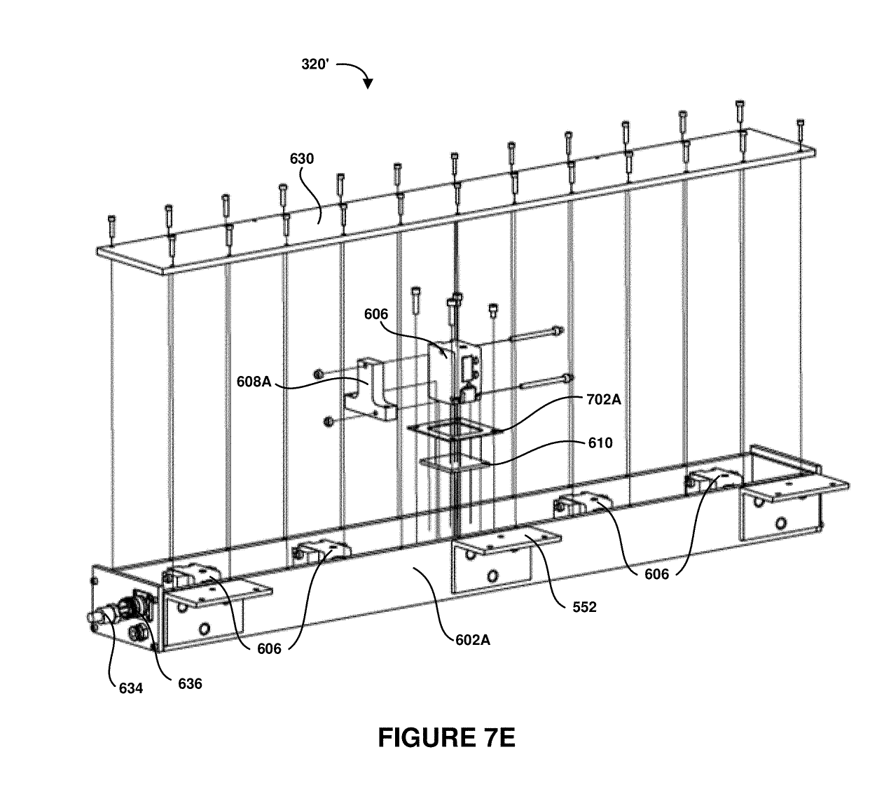

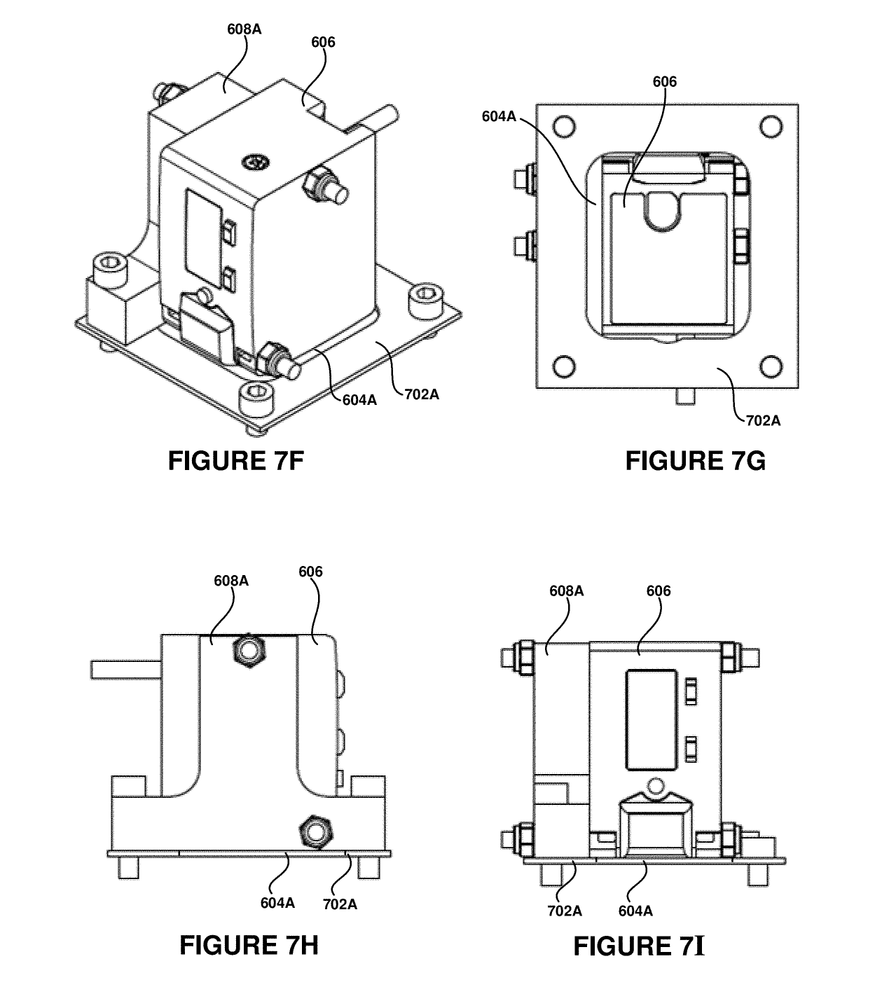

FIGS. 7A-D are simplified views of the sensor 606 and the sensor mounting bracket 608, for implementing embodiments of the present disclosure. FIG. 7A is a simplified isometric view of a sensor 606 and the sensor mounting bracket 608. FIG. 7B is a simplified bottom schematic view of the sensor 606 and the sensor mounting bracket 608. FIG. 7C is a simplified side schematic view of the sensor 606 and the sensor mounting bracket 608. FIG. 7D is a simplified top schematic view of the sensor 606 and the sensor mounting bracket 608. The sensor mounting bracket 608 includes a sensor opening 604′ corresponding to the sensor openings 604 in the sensor array housing 602. The optional window 610 can be secured between the sensor mounting bracket 608 and the sensor array housing 602.

The sensor mounting bracket 608 includes mounting tabs 702 for mounting to the sensor array housing 602. In at least one implementation, the mounting bracket 608 or portions thereof, can be supplanted by tabs (not shown) formed on the sensor 606.

FIG. 7E is a partially exploded view of an alternative sensor array 320′, for implementing embodiments of the present disclosure. The alternative sensor array 320′ includes a sensor array housing 602A. FIGS. 7F-I are simplified views of the sensor 606 and an alternative sensor mounting bracket 608A, for implementing embodiments of the present disclosure. FIG. 7F is a simplified isometric view of a sensor 606 and the alternative sensor mounting bracket 608A. FIG. 7G is a simplified bottom schematic view of the sensor 606 and the alternative sensor mounting bracket 608A. FIG. 7H is a simplified side schematic view of the sensor 606 and the alternative sensor mounting bracket 608A. FIG. 7I is a simplified top schematic view of the sensor 606 and the alternative sensor mounting bracket 608A. The alternative sensor mounting bracket 608 includes a sensor plate 702A including a sensor opening 604A corresponding to the sensor openings 604 in the sensor array housing 602, 602A. The optional window 610 can be secured between the sensor plate 702A and the sensor array housing 602.

The sensor 606 can include a laser emitter and detector, in at least one implementation. The laser emitter can include any suitable wavelength and power output. In at least one implementation, the laser emitter has an output wavelength within the ultraviolet (e.g., about 10 nm to about 400 nm), visible (e.g., about 400 nm to about 700 nm) and infrared (e.g., about 700 nm to about 1100 nm) ranges of the electromagnetic spectrum. In at least one exemplary implementation, the laser emitter emits a red laser light having a wavelength of between about 620 nm and about 700 nm. It should be understood that the foregoing example wavelengths are merely exemplary wavelengths that can be output by the laser emitter and that other color wavelengths, white wavelengths, ultraviolet wavelengths and infrared wavelengths can be utilized. It should also be understood that in various implementations, the laser emitter can output more than one wavelengths and different laser emitters included in the sensor array 320 can output different wavelengths.

In at least one implementation, the laser emitter output intensity is greater than the ambient lux from the sun and other light sources being used around the sensor array 320. In at least one implementation, the laser emitter output intensity is rated at between about 20,000 to 300,000 lux on the surface 102 and the surfaces of the plants and produce between the surface and the sensor array 320. In at least one implementation, the laser emitter output is rated at between about 50,000 to 100,000 lux.

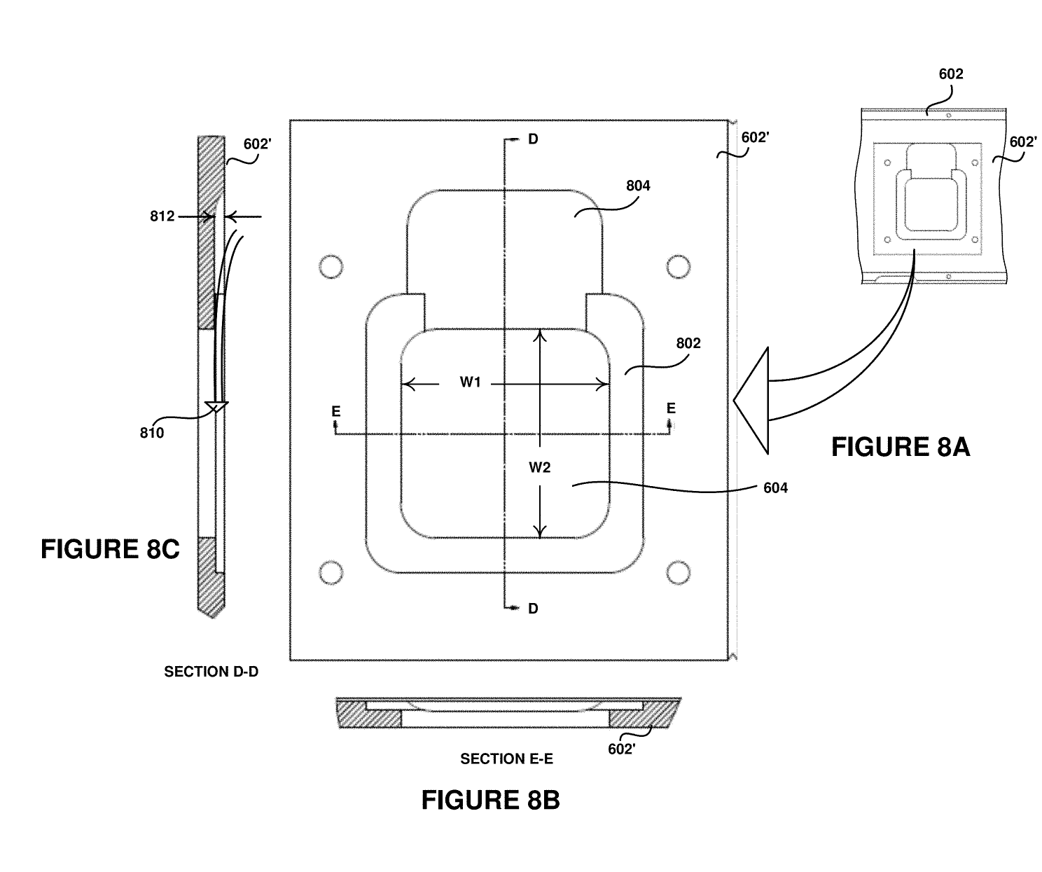

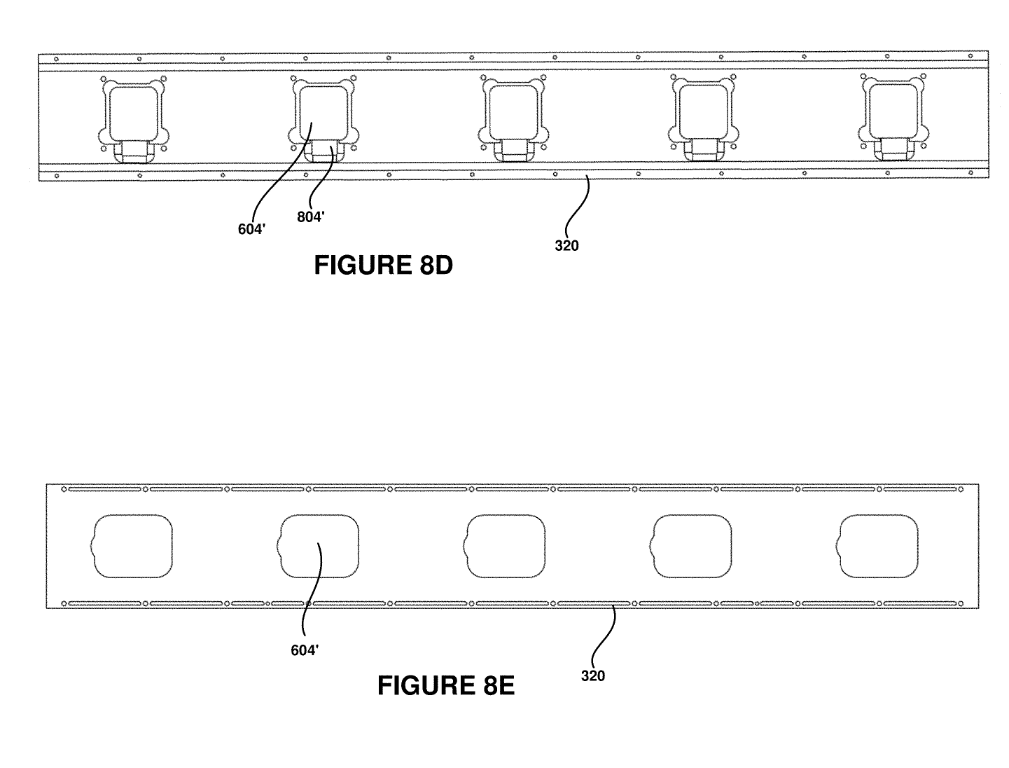

FIGS. 8A-C are detailed views of the sensor openings 604 in the sensor array housing 602, for implementing embodiments of the present disclosure. FIG. 8A is a top, detailed view of a portion of the sensor array housing 602 with a more detailed view of the sensor opening 604. FIG. 8B is a sectional view E-E of the detailed view of the sensor opening 604 in a portion 602′ of the sensor array housing 602. FIG. 8C is a sectional view D-D of the detailed view of the sensor opening 604 in a portion 602′ of the sensor array housing 602. FIG. 8D is a top view of a sensor array housing 602 with the top cover removed, for implementing embodiments of the present disclosure. FIG. 8E is a bottom view of a sensor array housing 602, for implementing embodiments of the present disclosure. The sensor opening 604 can be formed in a manner to allow pressurized gas (e.g., nitrogen, argon, air, dry air and combinations thereof) to be supplied to the sensor array housing 602 and escape around the sensor openings 604 in a manner that tends to remove dirt, plants, fluids, debris, condensation and other elements that might obscure the sensor during operation.

The sensor opening 604 includes a peripheral recess 802 and an extended side recess 804. The peripheral recess 802 forms a recess for supporting the window 610 in position. The sensor opening 604 has a first width W1 in a first direction and a second width W2 in a second direction. The sensor opening 604 first and second widths W1, W2 provides an area sufficient for the sensor 606 to emit a sensing pulse and receive and detect a reflected sensing pulse that is reflected from the surface 102 of the field 104 and the crops and produce disposed between the surface of the field and the sensor.

The extended side recess 804 provides a path 810 for pressurized gas to escape from the sensor array housing 602. The extended side recess 804 forms a nozzle directing pressurized gas at a desired window clearing pressure to pass or blow across the surface of the window 610. In this manner, dirt, plants, fluids, debris, condensation and other elements that might obscure the sensor during operation can be cleared away or otherwise removed from the surface of the window 610. The extended side recess 804 is substantially, but not necessarily fully, across one side of the window 610 and between about 0.25 mm and about 2.0 mm in depth 812.

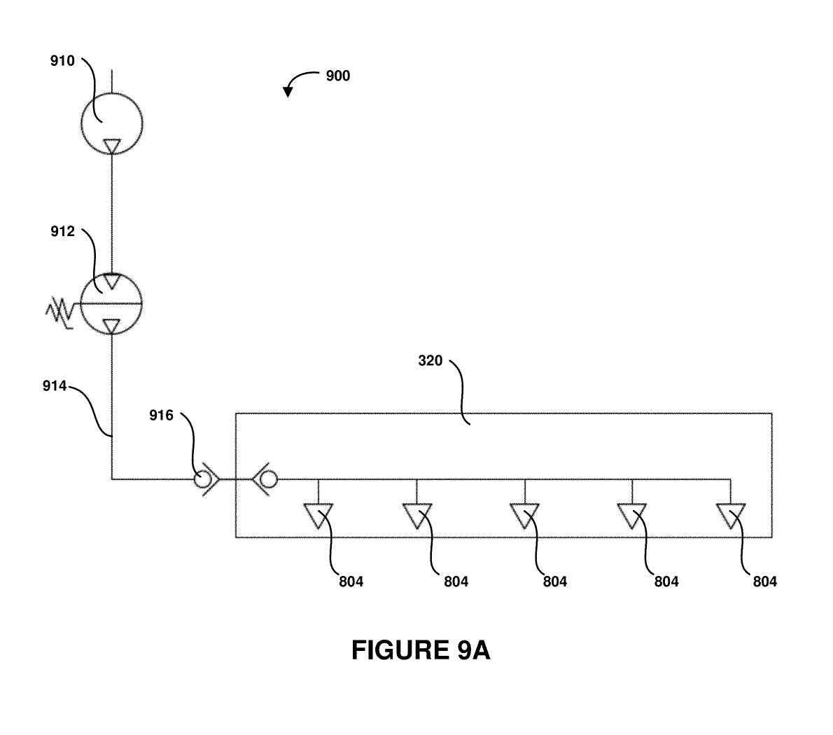

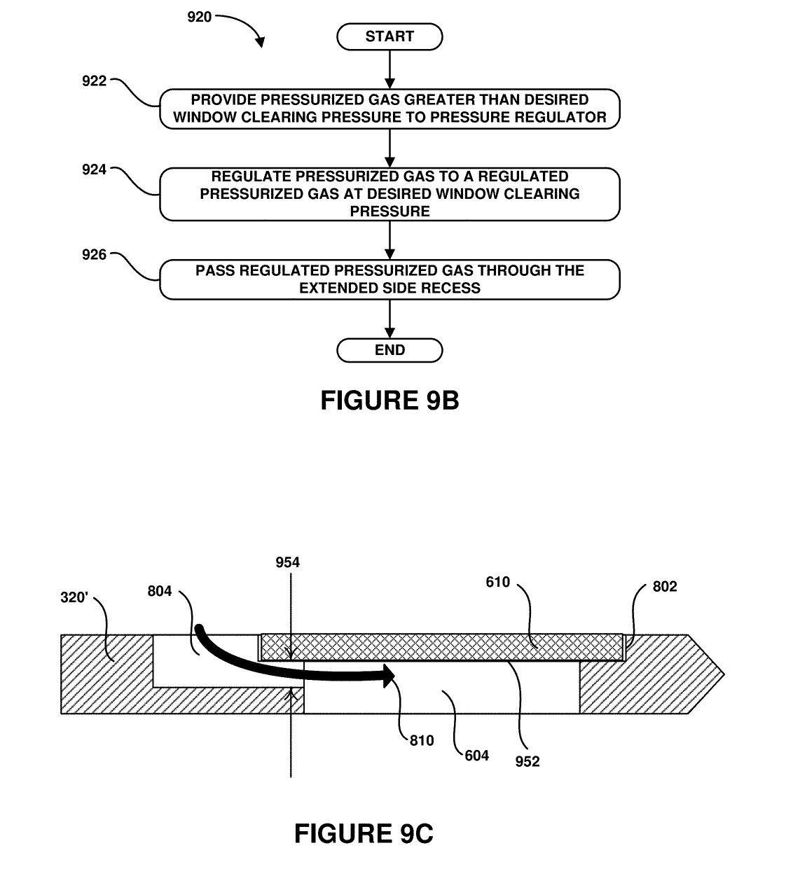

FIG. 9A is a piping and instrumentation diagram of a pressurized gas system 900 for delivering pressurized gas to the sensor array housing 602, for implementing embodiments of the present disclosure. The pressurized gas system 900 includes a pressurized gas source 910, a pressure regulator 912 and interconnecting gas lines 914 to couple the output of the pressure regulator to the pressure port 634 of the sensor array housing 602. Optional quick disconnect connector 916 is also shown. The pressurized gas source 910 can be any suitable source for the desired pressurized gas. In at least one implementation, the pressurized gas source 910 can be a pressurized bottle or other reservoir on the harvester. In another implementation, the pressurized gas source 910 can be an air compressor mounted on the harvester. The pressurized gas source 910 is capable of providing a pressure and flow great enough to perform the window clearing operation.

FIG. 9B is a flowchart diagram that illustrates the method operations 920 performed, in clearing the window 610, for implementing embodiments of the present disclosure. The operations illustrated herein are by way of example, as it should be understood that some operations may have sub-operations and in other instances, certain operations described herein may not be included in the illustrated operations. With this in mind, the method and operations 920 will now be described.

In an operation 922, pressurized gas source 910 provides a pressurized gas greater than desired window clearing pressure to the pressure regulator 912. In at least one implementation, the pressurized gas source 910 provides the pressurized gas at a pressure of between about 30 and about 200 psi, however higher pressures could also be utilized and are limited only by the capability of the pressure regulator 912.

In an operation 924, the pressure regulator 912 regulates the pressurized gas to output a regulated pressurized gas at the desired window clearing pressure. In at least one implementation, the desired window clearing pressure is between about 10 psi and about 50 psi greater than atmospheric pressure.

FIG. 9C is a sectional view of the sensor opening 604 in a portion 602′ of the sensor array housing 602, for implementing embodiments of the present disclosure. In an operation 926, the regulated pressurized gas passes through the extended side recess 804 and across the surface 952 of the window 610 to clear and otherwise substantially remove dirt, plants, fluids, debris, condensation and other elements that might obscure the sensor during operation. The extended side recess 804 forms a nozzle having a depth 954 and a width extending substantially across a first width W1 of the sensor opening 604. The depth 954 can be between about 0.02 mm and about 1.0 mm, depending on the pressure and flow rate of the pressurized gas. In one implementation, the depth 954 is between about 0.05 mm and about 0.10 mm and the pressurized gas has a pressure of between about 10 psi and 50 psi and a flow rate of between about 0.01 standard liters per minute (SLM) and about 25 SLM for one or more of the sensor openings 604. The operation 926 can be continuous during harvester operations or intermittently as a window 610 becomes obscured and in need of clearing. The method operations can end when the window 610 is no longer obscured or otherwise in need of clearing.

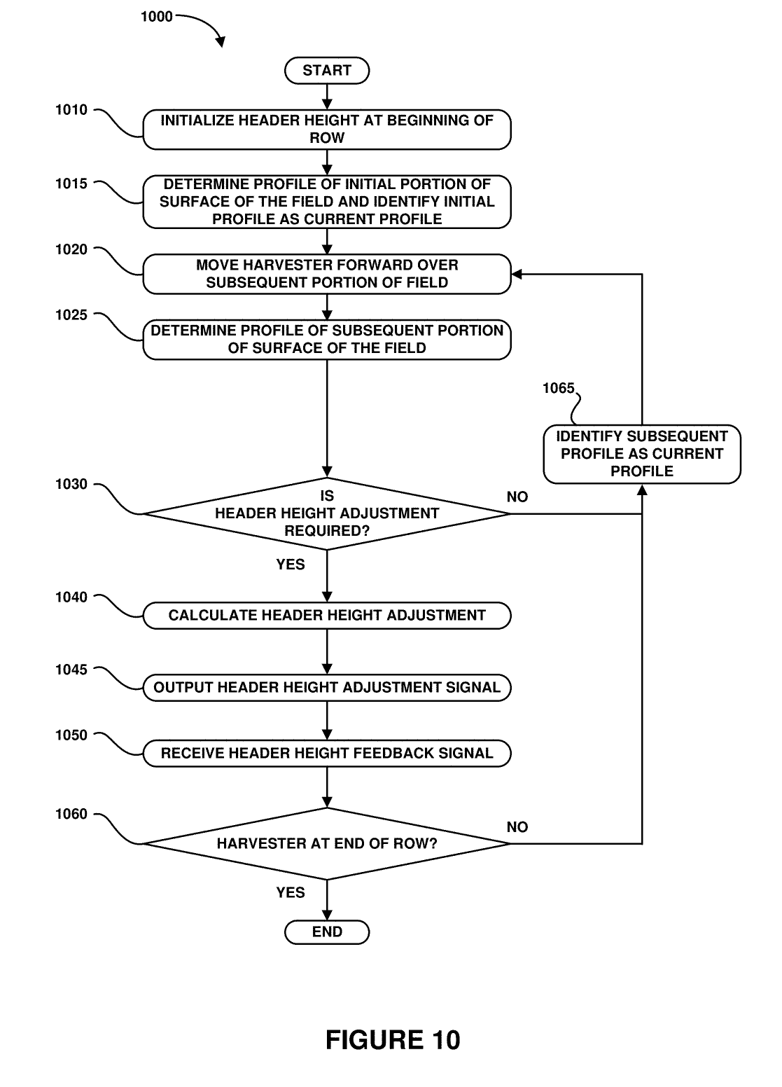

FIG. 10 is a flowchart diagram that illustrates an overview of the method operations 1000 performed, in determining and adjusting the height for the header during harvester operations, for implementing embodiments of the present disclosure. The operations illustrated herein are by way of example, as it should be understood that some operations may have sub-operations and in other instances, certain operations described herein may not be included in the illustrated operations. With this in mind, the method and operations 1000 will now be described.

In an operation 1010, the header controller 330 is initialized. Initializing the header controller 330 includes setting an initial desired header height. The initial desired header height can be manually selected by the operator of the harvester. Alternatively, the initial desired header height can be automatically selected by the header controller 330 based, at least in part, on the type of crop and the current header height.

In an operation 1015, a profile of an initial portion of the surface 102 of the field 104 is determined. The profile of the initial portion of the surface can be determined by moving the harvester forward over an initial portion of the field 104 as the sensor array 602 outputs multiple initial sensor signals. The multiple initial sensor signals are utilized by the header controller 330 to establish the initial profile of the surface 102 of the field 104. In one implementation, the initial desired header height is set before the header encounters the crop on the surface of the field and the initial forward movement of the harvester, in operation 1015, occurs before the header encounters the crop on the surface of the field. In other implementations, the initial desired header height may be set after the header encounters the crop on the surface of the field and/or the initial forward movement of the harvester, in operation 1015, can occur before or after the header encounters the crop on the surface 102 of the field 104. The initial profile is identified as a current profile for comparison as follows.

In an operation 1020, the harvester is moved forward over a subsequent portion of the surface 102 of the field 104 and the sensor array 602 continues to emit sensor pulses and receive reflected sensor pulses reflected from the surface of the field 102 and the plants and produce disposed between the surface and the sensors. The sensors output multiple sensor signals corresponding to the received reflected sensor pulses which the header controller 330 uses to determine a profile of the subsequent portion of the field, in an operation 1025. The profile of the subsequent portion of the field 102 is identified as a subsequent profile for comparison as follows.

In an operation 1030, the current profile is compared to the subsequent profile of the surface 102 of the field 104 in the header controller 330 to determine if a header height adjustment is required.

If, in operation 1030, a header height adjustment is needed, then the method operations continue in an operation 1040, where the header controller 330 calculates a header height adjustment. In an operation 1045, the header controller 330 outputs a header height adjustment signal corresponding to the calculated header height adjustment. The header height adjustment signal is output to the header height actuator 446 to adjust the height of the header. In an operation 1050, the header height feedback sensor 448 provides a corresponding header height feedback signal to the header controller 330. If, in operation 1060, the harvester has arrived at the end of the row, the method operations can then end. If the harvester has not arrived at the end of the row, then the method operations continue in an operation 1065 as the harvester continues to move across the surface 102 of the field 104.

If, in operation 1030, a header height adjustment is not needed, then the method operations continue in operation 1065. In operation 1065, the subsequent profile is identified as the current profile and the method operations continue in operation 1020 as described above. In this manner, the header height controller 330 continuously determines the height of header relative to the surface 102 of the field and adjusts the header height accordingly as the harvester moves across the surface of the field.

The header height controller uses various filtering techniques to differentiate between the surface 102 of the field and sensor signals reflected from the plants and produce disposed between the sensors and the surface of the field.

One of the filtering techniques includes identifying a maximum change in slope of the field. As an example, a plant can have a height of 200 mm and can be 5 mm offset from the side the surface 102 of the field. As a result, a measurement of relative to the surface may indicate 850 mm and only 5 mm offset from that measurement would indicate 650 mm with an effective slope of 200/5=4000 percent slope which would be much greater than a possible slope of a field as a typical field slope would rarely exceed 20 percent and typically would be about 10 percent or less.

However, to further smooth the actuation of the header height adjustment, the header controller 330 uses an average of multiple header height calculations as the current profile in a first in first out process where the latest distance measurement pushes out the oldest distance measurement such that the current profile is based on the latest set of distance measurements. By way of example, a current profile can include the latest 50 distance measurements, e.g., distance measurements 1-50, and the 51^{st} distance measurement would push distance measurement 1 out of the set of distance measurements used to calculate the current profile. In this manner, the profile of the surface of the field is accurately identified as the harvester moves across the field 104. As the surface of the field is accurately identified, the header height can be accurately and quickly adjusted to compensate for detected variations in the profile of the surface 102 of the field 104.

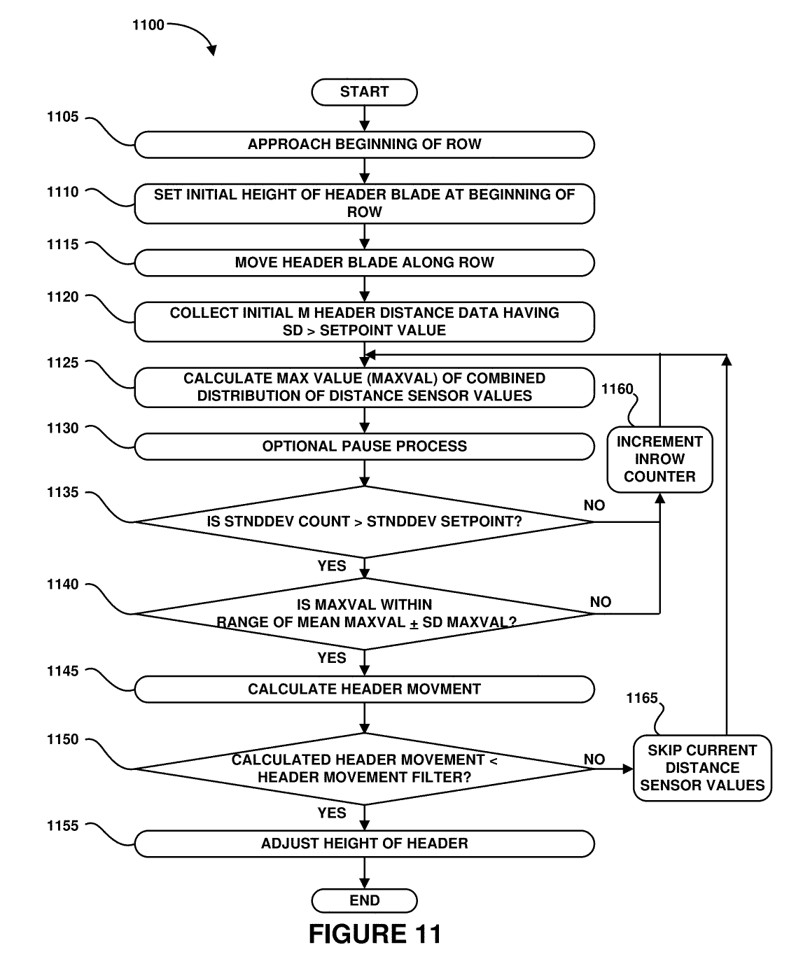

FIG. 11 is a flowchart diagram that illustrates a more detailed view of the method operations 1100 performed, in determining and adjusting the height for the header during harvester operations, for implementing embodiments of the present disclosure. The operations illustrated herein are by way of example, as it should be understood that some operations may have sub-operations and in other instances, certain operations described herein may not be included in the illustrated operations. With this in mind, the method and operations 1100 will now be described.

In an operation 1105, the harvester 210 approaches the beginning of a row to be harvested. In an operation 1110, the header blade 212 is placed an initial distance from the surface 102 of the field 104. The header blade 212 height is controlled by the height of the header 250. In one implementation, the header blade 212 can be placed on the surface 102. In another alternative implementation, the header blade 212 can be placed above the surface 102 a known or approximated distance. In yet another alternative implementation, the header blade 212 can be placed below the surface 102 a known or approximated distance. Placing the header blade 212 the initial distance from the surface 102 of the field 104 can be performed manually by the operator of the harvester 210. Alternatively, the header height controller 330 can automatically adjust the height of the header 250 and the header blade 212 to a preselected distance above, on or below the surface 102. The distance to the surface can be measured using one or more sensors 606 in the sensor array 320. Alternatively, or additionally, one or more sensors on the header 250 can be used to determine the header blade 212 height relative to the header. By way of example, a linear potentiometer mounted on one of more portions of the header 250 can measure the movement and height of the header blade 212, relative the header. Similarly, one or more sensors can be coupled to other portions of the header 250 such as the wheels 217 to detect the surface of the ground.

In an operation 1115, the harvester 210 begins moving forward to harvest the crop in the field. The harvester 210 moves the header blade 212 through the crop as the harvester moves forward. The sensor array 320 also moves forward as the harvester 210 moves forward.

The sensor array 320 emits multiple distance measuring pulses as the harvester 210 and the sensor array move forward. In an operation 1120, the sensor array 320 emits and receives “n” initial distance measuring pulses, where n can be within a range of between about 2 and about 10,000. In one implementation, n is within a range of between about 2 and about 1000. In another implementation, n is within a range of between about 2 and about 100. In one exemplary implementation, n is equal to about 50. In another implementation, n is equal to about 2000. In another implementation, n is equal to about 500. A greater number of initial pulses can be used to determine a more accurate initial profile of the surface of the field.

In one implementation, the number of distance measuring pulses can vary with the forward velocity of the harvester 210. By way of example, the number of distance measuring pulses can be between about 1 and about 1000 pulses per 25 mm of forward movement of the harvester 210. In at least one implementation, the distance measuring pulses can be independent of the distance of forward movement of the harvester 210.

In at least one implementation, the distance measuring pulses can have a pulse rate of between about 1 pulse per millisecond and about 1 pulse per second (i.e., about 1 pulse per 1000 milliseconds). In at least one embodiment, the distance measuring pulses can have a pulse rate between about 1 pulse per 5 milliseconds and 1 pulse per 100 milliseconds. In one exemplary implementation, the distance measuring pulses can have a pulse rate of between about 1 pulse per 1 millisecond and about 1 pulse per 30 milliseconds. In one exemplary implementation, the distance measuring pulses can have a pulse rate of about 1 pulse per 10 milliseconds.

The pulse rate of the distance measuring pulses can be constant. Alternatively, the pulse rate of the distance measuring pulses can be variable based on factors such as error rates, horizontal velocity of the harvester or other factors. In at least one implementation, each distance measuring pulse includes a single sensor pulse from each of the multiple sensors 606. By way of example, in a sensor array 320 having 5 sensors 606, each distance measuring pulse would include one sensor pulse from each sensor, for a total of 5 sensor pulses. In another implementation, with a sensor array having 25 sensors, each distance measuring pulse would include one distance measuring pulse from each sensor 606, for a total of 25 sensor pulses.

The pulse rate of the distance measuring pulses can be constant from all of the sensors 606. Alternatively, the pulse rate of the distance measuring pulses from one sensor 606 may be higher or lower than a different sensor. By way of example, a sensor 606 in that is more centrally located to the row of crops being harvested may have a pulse rate that is higher or lower than a pulse rate of a sensor located closer to the edges of the row.

The sensor array 320 outputs distance data with each received distance measuring pulse. The output distance data for n initial distance measuring pulses is received in the differentiating system 406 in the header height controller 330. The differentiating system 406 examines the n distance data from the n initial distance measuring pulses to identify a set number m distance data having a standard deviation greater than a preselected standard deviation, where m can have various implementations having similar ranges and values as n described above.

The standard deviation identifies a range of acceptable or realistic values of distance data output by the sensors 606. Distance data having values greater than the selected standard deviation are either too far or too near to the sensor 606 to be used. By way of example, if one of the sensors has a distance data value of 10 mm and the other sensors are outputting distance data within about 20 mm of 230 mm then the 10 mm value is not representative of a valid distance measurement. Similarly, if one sensor has a distance data value of 2110 mm and the other sensors are outputting distance data within about 20 mm of 230 mm then the 2110 mm value is not representative of a valid distance measurement. The distance data falling outside the standard deviation is ignored, in at least one implementation.

In one implementation, the number n of distance data is between about 2 and about 5000 distance data. In one implementation, the number n of distance data is between about 10 and about 100 distance data. In one implementation, the number n of distance data is between about 2000 distance data. In one implementation, the number n of distance data is between about 500 distance data. In one implementation, the number n of distance data is a fixed number of distance data. In one implementation, the number n of distance data is 50 distance data.

In one implementation the distance data is filtered to remove out of range distance data. By way of example, if a received distance data is at or near a selected max distance value, then the distance data value is removed from the distance data or otherwise ignored or filtered out of the distance data. In another implementation, if a received distance data is at or near a selected max distance value, then the received distance data value is set to zero “0” value and ignored in subsequent standard deviation calculations.

The selected max distance data value can be selected. In one implementation, the selected max distance data value is substantially equal to the furthest distance between the surface of the ground and the header with the header at a maximum highest raised position. In another implementation, the selected max distance data value can be a value greater than about one half of the furthest distance between the surface of the ground and the header with the header at a maximum highest raised position.

The preselected standard deviation can be preselected by an operator or within a setting of the header height controller 330 such as between about 0.4 and about 0.8. In one exemplary implementation, the preselected standard deviation is set at 0.6. Alternatively, the preselected standard deviation can be determined based on past history with harvesting the crop presently being harvested. By way of example, the preselected standard deviation can be a first value for peppers, a second value for cucumbers and a third value for tomatoes and so forth with preselected standard deviation values corresponding to many other crops that may be harvested by the harvester 210.

In an operation 1125, a combined distribution of the m distance data is examined to identify one of the m distance data having the highest value and identifying that value as a max value (maxval). The max value corresponds to a maximum distance data value in the m distance data values received from the sensors 606.

An optional pause operation 830 can be implemented at any time within the method operations 1100. The pause operation pauses the adjustment of the header height. And can be initiated by the operator of the harvester 210. The pause operation may be initiated so that the operator can make a manual adjustment to the harvester or for any other reason deemed necessary by the operator.

In an operation 1135, a STNDEV counter is compared to a STNDEV counter setpoint value. The STNDEV counter counts the number of distance data calculations that have reached this point in the method operations to provide sufficient numbers of distance data points to have a basis of comparison for future received distance data values.

It should be noted that the numbers of distance data values received can be many 100s or 1000s within a few seconds of operation of the harvester 210 and that the maxval will be assumed to be the distance between the sensor and the surface 102 of the field 104 and thus representative of an accurate distance to the surface. The other distance values are assumed to be distance values measured to plants, stems, vines, leaves and produce in the field, thus differentiating between the surface 102 and the crop being harvested.

If the STNDEV counter is not greater than a STNDEV counter setpoint value, then the method operations continue in an operation 1160. If the STNDEV counter is greater than a STNDEV counter setpoint value, then the method operations continue in an operation 1140.

In operation 1140, the maxval identified in operation 1125 is compared to a range of mean maxval±a standard deviation of the maxval. The standard deviation of the maxval can be a preselected value. By way of example the standard deviation of the maxval can be between about 0.4 and about 1.0. In at least one implementation, distance values determined to be out of range are filtered out before the standard deviation is calculated. Filtering to remove out of range distance values before calculating the standard deviation provides a more reliable and more accurate calculation of the standard deviation. By way of example, an about 10 volt sensor output corresponds to a maximum measurable distance. This maximum measurable distance can vary between about 60 mm and about 1000 mm as may be defined by the sensor specifications. In one exemplary implementation, setting a 10 volt sensor output signal as an out of range value reading on a sensor having a maximum sensor range setting of 1000 mm and a sensor output signal greater than about 9.0 volts can be considered out of range would result in the distance values greater than about 900 mm being filtered out and not used in the standard deviation calculations.

If the maxval identified in operation 1125 not within the range of the mean maxval±a standard deviation of the maxval, then the method operations continue in operation 1160. This would occur when the maxval identified in operation 1125 is too high or too low and thus some error in the earlier processing of the distance data is assumed and the maxval is discarded, in at least one implementation, and inrow counter in incremented in operation 1160 and a new maxval is identified from the received distance data in operation 1125 as described above.

In at least one implementation, the standard deviation of the maxval is determined by testing based on maximum horizontal velocity of the harvester and a maximum projected positive or negative slope in the field for a given distance. By way of example, a maximum positive and negative slope can be selected at 8 percent, a maximum horizontal velocity of the harvester set at about 2.5 meters per second and a maximum distance of the detected slope of about 1 meter. Such settings would indicate that if the detected positive or negative slope is less than 8 percent, and the harvester is moving less than about 2.5 meters per second and the maximum distance that the 8 percent incline or decline was detected was less than 1 meter, then the header was within what is considered an expected range of variation. If one or more of the detected slope, harvester horizontal velocity or distance of the detected slope was greater than the foregoing example settings, then the detected change was greater than the expected range of variation and header height control system can presume an error has occurred in at least one process of detecting and/or calculating at least one of the settings and thus no adjustment to the header height is made. It should be understood that the foregoing example positive or negative slope percentage, harvester horizontal velocity or distance of the detected slope can vary based on the horizontal quality of the field being harvested.

By way of example, if the field is substantially flat with very little variation then the slope (e.g., less than 1 percent variation in positive or negative slope), harvester horizontal velocity can be much faster (e.g., between about 2.5 and 8 meters per second) and/or distance of the detected change in slope can be shorter (e.g., between about 200 mm and about 800 mm) and thus the standard deviation of the maxval would result in a much narrower range of expected variations in the surface of the field and the header height would be adjusted accordingly. Conversely, if the field had a widely varying slope then header height adjustments can be applied more often as the standard deviation of the maxval is wider and would reduce the number of presumed errors in detecting or calculating one of the settings described above.

If the maxval identified in operation 1040 is within the range of the mean maxval±a standard deviation of the maxval or, in an alternate implementation, a set fraction of a standard deviation, then the method operations continue in operation 1045.

In operation 1145, the distance calculating system 408 calculates the distance between the sensors 606 and the surface 102 and the header controller 330 calculates a potential adjustment to the header height. In an operation 1150, the calculated potential adjustment to the header height is compared to a header movement filter value. The header movement filter value prevents the header from being moved very large amounts. By way of example, if the calculated potential adjustment to the header height is a 100 mm change from a current header height, then the header height might not need to be adjusted, if 100 mm is more than the header movement filter value. In another implementation, small header movement values may be similarly filtered out. By way of example, if the calculated potential adjustment to the header height is a relatively small value such as between about 1 mm and about 5 mm change from a current header height, then the header height might not need to be adjusted, if 5 mm is less than a minimum header movement filter value.

If the calculated potential adjustment to the header height is not greater than the header movement filter value, then the method operations continue in an operation 1165 where no header height adjustment is made and the method operations then continue in operation 1125 as described above where the next potential header height adjustment is calculated based on subsequently received distance data values.

If the calculated potential adjustment to the header height is greater than the header movement filter value, then the method operations continue in an operation 1155 where the header controller 330 initiates the header height adjustment mechanisms 335 a corresponding amount to adjust the header height and the method operations then continue in operation 1125 as described above where the next potential header height adjustment is calculated based on subsequently received distance data values. Alternatively, if no further header height adjustments are needed, such as when the harvester reaches the end of a row of crops being harvested, then the method operations can end.

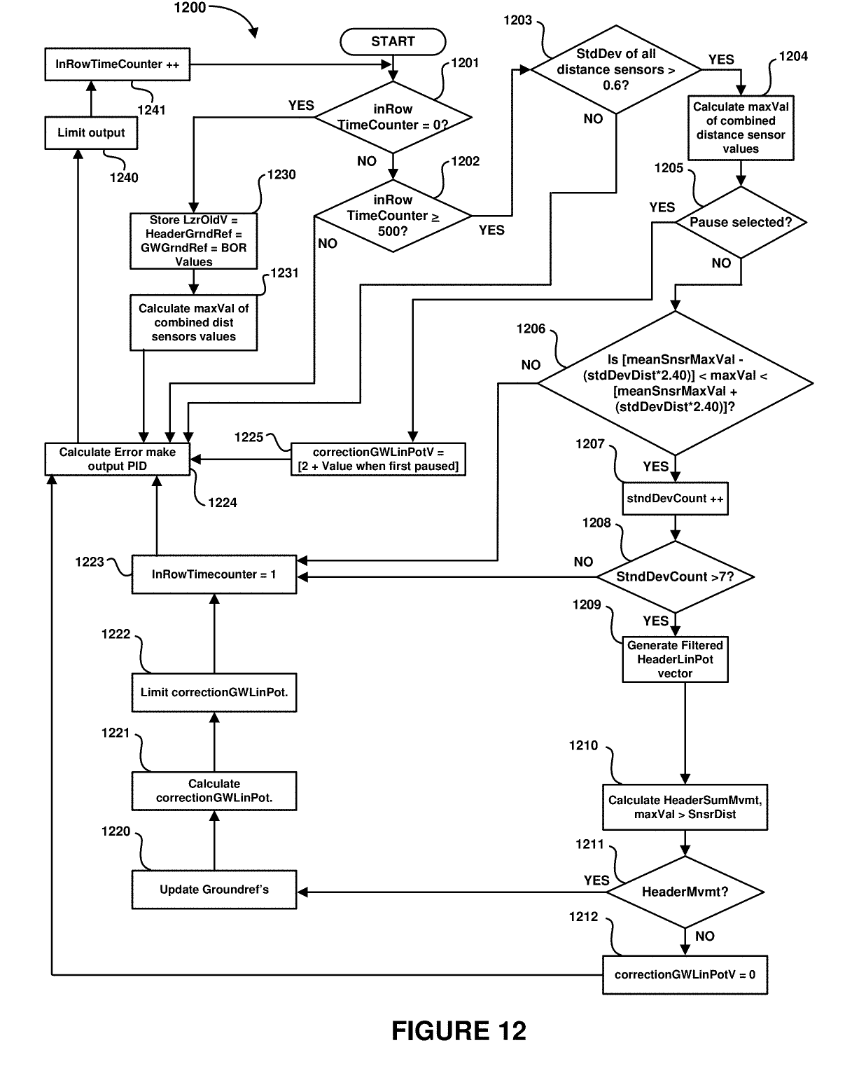

FIG. 12 is a more detailed flowchart diagram that illustrates the method operations 1100 performed, in calculating the standard deviation height for the header, for implementing embodiments of the present disclosure. The operations illustrated herein are by way of example, as it should be understood that some operations may have sub-operations and in other instances, certain operations described herein may not be included in the illustrated operations. With this in mind, the method and operations 1200 will now be described.

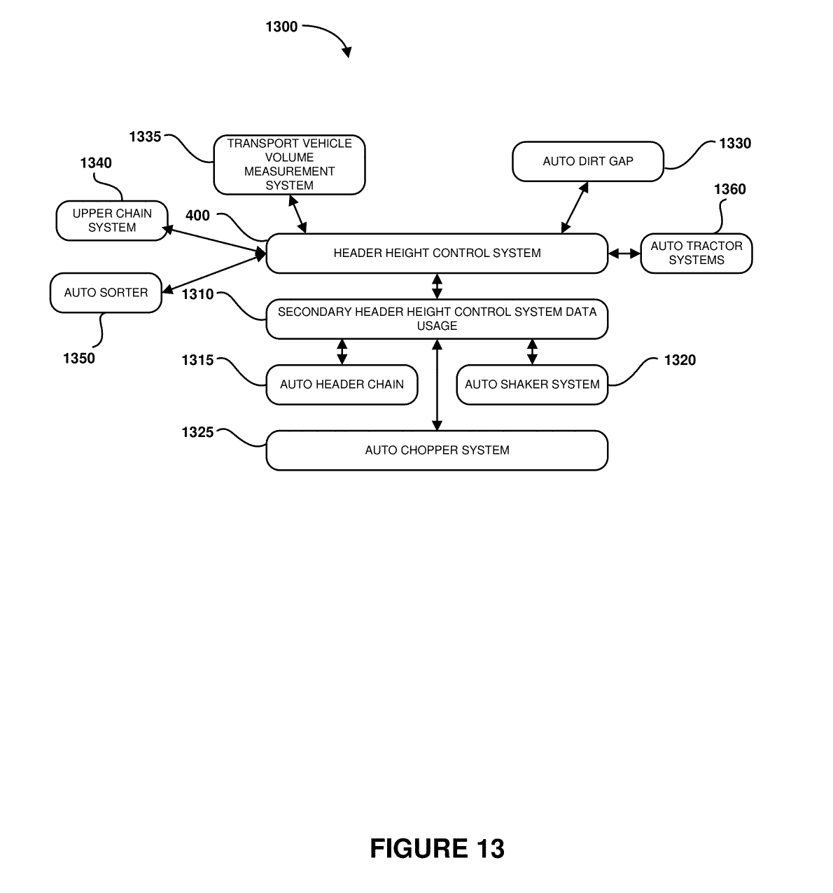

FIG. 13 is a simplified block diagram 1300 of multiple automatic systems that can interact during harvester operations, for implementing embodiments of the present disclosure. The automatic header height control system 400 described above allows the header height to be adjusted to optimize harvesting of the produce. As described above, many different calculations are performed and many data points are collected during the process of optimizing the header height to provide peak yield of the harvesting of the produce.

To further maximize the yield of the harvested produce, several additional systems can also be optimized. An auto dirt gap system 1330 can also be installed on the harvester 210. The auto dirt gap system 1330 automatically adjust the dirt gap to optimize the amount of dirt passing through the dirt gap and maximize the amount of produce passing over the dirt gap. The auto dirt gap system 1330 includes a produce monitor monitoring the amount of produce passing through the dirt gap. The auto dirt gap system 1330 automatically reduces the dirt gap when the amount of produce passing through the dirt gap exceeds a set point value.

The auto dirt gap system 1330 can also monitor for a quantity of plants, i.e., tomato vines, that are harvested with the produce and the dirt. An increase in the density of the plants can also indicate an increase in health of the vines and the density of the plants in the ground. This plant density value can be output to the header height control system 400 and other systems such as plant health monitoring databases to identify healthier, denser, higher yield portions of the field. This plant density value can then be used for speed control of the harvester and for identifying irrigation regions and fertilizer, herbicide and pesticide application regions for the field being harvested.

The auto dirt gap system 1330 also monitors the quantity of dirt picked up by the header of the harvester. An increase in the quantity of dirt harvested by the header indicates the header is too low. The auto dirt gap system 1330 can then output an excess dirt indication to the header height control system 400 at the header is too low. The header height control system 400 can use the excess dirt indication from the auto dirt gap system 1330 to adjust the header height.

Secondary uses auto header height systems data 1310 can include data collection of plant density, similar to that described above with regard to the auto dirt gap system 1330 to provide for mapping the health and yield of the field being harvested.

Another secondary use of the auto header height systems data 1310 is an operator metric. Where the yield of the harvester can be correlated to the operator of the harvester and the region of the field. This operator metric could be used to control the harvester if the harvester is automated. This operator metric could also be used to indicate the operator needs additional training to further optimize the yield of the field being harvested. The yield of each region of the field can be mapped to produce a yield map of the field. The yield map can include plant density and produce yield which correlates to various health aspects of the crop in the field.

Yet another secondary use of the auto header height systems data 1310, is an indicator of field topography. If the field topography is excessively erratic, then the amount of dirt harvested by the harvester will be similarly erratic and the yield of the produce may also be similarly erratic. The field topography can be captured by the auto header height systems 400.

Yet another secondary use of the auto header height systems data 1310, is to provide operating data for an auto header chain system 1315. The auto header chain system 1315 controls the speed of the header chain. The speed of the header chain determines a proper density pack for the harvested produce and plants for delivery to an auto shaker system 1320. The density of the pack can be detected using a camera or a second laser scanning system, similar to the laser array used in the header height control system 400, as described above. The density detection can be used to setup and provide feedback adjustments to the operations of the shaker system.

Upper header chain system 1340 creates a proper feed rate for the auto shaker system. The upper header chain system 1340 slows or speeds up the upper header chain in correlation to the auto header chain and the density pack. The upper header chain system 1340 can also warn the shaker system to increase or decrease shake intensity.

The auto shaker system 1320, auto adjust to shake the speed and intensity to minimize produce damage and loss while minimizing system clogs of produce. The auto shaker system 1320 can also output an indicator to the harvester operator and/or the header height control system 400, to slow the harvester. The auto shaker system 1320 can also produce a map of the plant density in the field based on a difficulty of separation of the plants and produce that are harvested by the harvester. The auto shaker system 1320 can be coupled to the auto header chain and the upper header chain speed control. The auto shaker system 1320 can also provide indications to the auto chopper system 1325 for controlling the operations of the auto chopper system.

Auto sorter system 1350 can include one or more robotic arms for sorting dirt and produce. The robotic arms can include six axis robotic arms or parallel robotic arms, or combinations thereof. The auto sorter system 1350 differentiates objects other than the produce and pick them from the produce passing by the auto sorter system. The auto sorter system 1350 would include a vision system. A laser scanner similar to that described above for the header height control system could be included in the vision system for the auto sorter system 1350.

Auto chopper system 1325 can regulate and otherwise control of the chopper and the feed rate into the chopper to decrease plug ups based on the produce and plant material exiting the auto shaker system.

A transport vehicle volume measurement system 1335 can also be included in the systems that can communicate with the auto header height system 400. The transport vehicle volume measurement system 1335 measures the volume of produce, dirt, and plant material that are delivered from the harvester to the transport vehicle 230. The transport vehicle volume measurement system 1335 can use a similar array of lasers or one or more scanning lasers or combinations thereof, to measure the quantity of produce, dirt, and plant material in the transport vehicle so as to optimize the load carrying capabilities of the transport vehicle and thus optimize the transport of the produce from the field to the processing plant. Without an accurate transport vehicle volume measurement system, the transport vehicle may be under loaded or overloaded. Under loaded transport vehicles require access numbers of transport vehicles to harvest the field. Overloaded transport vehicles can be unsafe and can result in damage produce and can result in overloaded vehicle fines.

The transport vehicle volume measurement system 1335 can also field yield and harvester operator yield performance data that can be fed back to the auto header height system 400 to better identify aspects of operating the auto header height system such as forward speed and header height.

Auto tractor systems 1360 control the tractor speed and direction. Auto tractor systems 1360 can be used for tractors such as the transport vehicles 230. In one implementation the auto tractor systems 1360 control the tractor during in row to fill the trailer 230 to a given, even level. As speed of the harvester increases or decreases the tractors correspondingly increase or decrease to keep pace with the harvester. A datalink can be established between the control system of the harvester and the auto tractor system 1360 to control the speed of the tractor. Similarly, the auto tractor system 1360 can use one or more sensors to monitor the speed of the harvester and maintain pace with the harvester without a specific data link between the auto tractor systems and the harvester. The auto tractor system 1360 can increase production at higher speeds.

An auto elevator actuation system 1370 and also interact with the auto tractor system 1360 and/or the header height control system 400. The auto elevator actuation system 1370 improves the accuracy and filling the transport vehicles 230 and allows an auto tractor system to work more efficiently with the harvester, specifically at the ends or beginnings of the rows being harvested.

With the above embodiments in mind, it should be understood that the disclosure may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

The disclosure may be practiced with other computer system configurations including hand-held devices, microprocessor systems, microprocessor-based or programmable consumer electronics, minicomputers, mainframe computers and the like. The disclosure may also be practiced in distributing computing environments where tasks are performed by remote processing devices that are linked through a network.

With the above embodiments in mind, it should be understood that the disclosure may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the disclosure are useful machine operations. The disclosure also relates to a device or an apparatus for performing these operations. The apparatus may be specially constructed for the required purpose, such as a special purpose computer. When defined as a special purpose computer, the computer can also perform other processing, program execution or routines that are not part of the special purpose, while still being capable of operating for the special purpose. Alternatively, the operations may be processed by a general purpose computer selectively activated or configured by one or more computer programs stored in the computer memory, cache, or obtained over a network. When data is obtained over a network the data maybe processed by other computers on the network, e.g., a cloud of computing resources.

The embodiments of the present disclosure can also be defined as a machine that transforms data from one state to another state. The transformed data can be saved to storage and then manipulated by a processor. The processor thus transforms the data from one thing to another. Still further, the methods can be processed by one or more machines or processors that can be connected over a network. Each machine can transform data from one state or thing to another, and can also process data, save data to storage, transmit data over a network, display the result, or communicate the result to another machine.

The disclosure can also be embodied as computer readable code on a computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, DVDs, Flash, magnetic tapes, and other optical and non-optical data storage devices. The computer readable medium can also be distributed over a network coupled computer systems so that the computer readable code is stored and executed in a distributed fashion. The computer readable medium can also include logic embodied in an integrated circuit such as within a portion of a microprocessor, an application specific integrated circuit or other programmable logic array that can be utilized to provide non-volatile logic that can embody one of more portions of the processes described herein and can then be used by the processor for performing the processes.

It will be further appreciated that the instructions represented by the operations in the above figures are not required to be performed in the order illustrated, and that all the processing represented by the operations may not be necessary to practice the disclosure. Further, the processes described in any of the above figures can also be implemented in software stored in any one of or combinations of the RAM, the ROM, or the hard disk drive.

Although the foregoing disclosure has been described in some detail for purposes of clarity of understanding, it will be apparent that certain changes and modifications may be practiced within the scope of the appended claims. Accordingly, the present embodiments are to be considered as illustrative and not restrictive, and the disclosure is not to be limited to the details given herein but may be modified within the scope and equivalents of the appended claims.

What is claimed is:

1. A method of measuring distance to a surface comprising:
scanning the surface with a laser array, wherein a plurality of plants and produce are disposed on the surface, the scanning including:
passing the laser array over the surface, a first portion of the plants and a first portion of the produce extending from the surface toward the laser array, the first portion of the plants and the first portion of the produce covering a first portion of the surface;
delivering the surface scanning data from the laser array to a differentiating system;
differentiating a second portion of the surface from the first portion of the plants and the first portion of the produce in the differentiating system, wherein the second portion of the surface is not covered by the first portion of the plants;
outputting a differentiating data from the differentiating system to a distance calculating system;
determining a surface distance between the laser array and the second portion of the surface in the distance calculating system; and
outputting the surface distance from the distance calculating system to a header height control system.

2. The method of claim 1, further comprising:
determining a target harvesting height of a header on a harvester in the header height control system, the target height derived from the surface distance; and
activating a plurality of header height adjusting devices to adjust a current height of the header to the target height.

3. The method of claim 2, further comprising harvesting the plurality of plants and produce including moving the header through the plurality of plants and produce at the target harvesting height.

4. The method of claim 3, further comprising;
detecting a change in the surface distance as the header is moving through the plurality of plants and produce.

5. A method of differentiating a plurality of plants from the surface where the plants are growing comprising:
scanning the surface with a laser array, wherein, the scanning including:
passing the laser array over the surface, a first portion of the plurality of plants extending from the surface toward the laser array, the first portion of the plurality of plants covering a first portion of the surface;
delivering the surface scanning data from the laser array to a differentiating system;
differentiating a second portion of the surface from the first portion of the plurality of plants in the differentiating system, wherein the second portion of the surface is not covered by the first portion of the plurality of the plants;
outputting a differentiating data from the differentiating system to a distance calculating system;
determining a surface distance between the laser array and the second portion of the surface in the distance calculating system; and
outputting the surface distance from the distance calculating system to an indicator for display of a height of the plurality of plants.

6. A system for adjusting a header height for a harvester comprising:
a header coupled to the harvester by a header height adjusting system, the header height adjusting system including a controller, a header height measuring and monitoring system and a scanning system capable of measuring the current height of the header relative to a surface of the field, the header height adjusting system being capable of adjusting the current height of the header relative to the surface of the field to a desired harvesting height, relative to the surface of the field, as the harvester moves across the surface of the field.

7. The system of claim 6, wherein the desired harvesting height is below the surface of the field.

8. The system of claim 6, wherein the desired harvesting height is above the surface of the field.

9. The system of claim 6, wherein the desired harvesting height is substantially equal to the surface of the field.

10. The system of claim 6, wherein the scanning system includes a sensor array including a plurality of sensors, the plurality of sensors being directed toward the surface of the field.

11. The system of claim 6, wherein the scanning system includes at least one laser emitter and sensor capable of emitting a laser toward the surface of the field and detecting a reflection of the laser.

12. The system of claim 11, wherein at least a first portion of the laser is reflected from the surface of the field and at least a second portion of the laser is reflected from plants disposed between the surface of the field and the sensor.

13. The system of claim 12, further including a differentiating system capable of differentiating between the surface of the field and plants disposed between the surface the field and the sensor.

14. The system of claim 6, wherein the scanning system includes at least one scanning sensor capable of scanning from a first side of a row being harvested to a second side of the row being harvested.
